(19) United States
(12) Patent Application Publication
(10) Pub. No.: US 2003/0215957 A1
(43) Pub. Date: Nov. 20, 2003

(54) Multi-channel dispensing system

(76) Inventors: Tony Lemmo, Durham, NC (US); Michelle Rodriguez, Mission Viejo, CA (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/445,625

(22) Filed: May 27, 2003

Related U.S. Application Data
(63) Continuation of application No. 09/372,719, filed on Aug. 11, 1999, now abandoned.
(63) Continuation of application No. 09/253,221, filed on Feb. 19, 1999, now abandoned.
(60) Provisional application No. 60/075,401, filed on Feb. 20, 1998.

(51) Int. Cl. G01N 1/10

(52) U.S. Cl. 436/180; 422/100

(57) ABSTRACT

A multi-channel dispensing system particularly adapted for dispensing and aspirating precise and/or predetermined quantities of one or more fluids. The multi-channel dispensing system includes a multi-channel manifold positioned intermediate and in hydraulic communication with a positive displacement pump and a plurality of drop-on-demand valves. The pump is adapted to provide an incremental quantity or continuous flow of fluid to the drop-on-demand valves. The multi-channel dispensing system can dispense controlled and/or generally equal quantities and/or flow rates of fluid(s) through one or more channels by opening and closing one or more of the drop-on-demand valves at predetermined frequencies and/or duty cycles.

### RELATED APPLICATIONS

This application is a continuation of U.S. application Ser. No. 09/253,221 filed Feb. 19, 1999, which claims the priority benefit of U.S. Provisional Application No. 60/075,401 filed Feb. 20, 1998.

### BACKGROUND OF THE INVENTION

1. Field of the Invention

The present invention relates generally to an apparatus for dispensing reagents and other liquids and, in particular, to a multi-channel dispense/aspirate system incorporating a manifold and array of dispensing nozzles for dispensing/aspirating precise and/or predetermined quantities of chemical/biological reagents.

2. Background of the Related Art

Microfluidic dispense/aspirate technology has a wide variety of research and non-research related applications in the biodiagnostics, pharmaceutical, agrochemical and material sciences industries. Dispense systems are utilized in drug discovery, high throughput genetic screening, live cell dispensing, combinatorial chemistry and test strip fabrication among others. These systems may be used for compound reformatting, wherein compounds are transferred from one plate source, typically a 96 microwell plate, into another higher density plate such as a 384 or 1536 microwell plate. Compound reformatting entails aspirating a sample from the source plate and dispensing it on the target plate. In these and other applications it is desirable, and sometimes crucial, that the dispense system operate efficiently, accurately and reliably. The microfluidic aspect of these applications further adds to the complexity of handling and transferring such small quantities of fluid.

Conventional dispense/aspirate methods and technologies are well known in the art, for example, as disclosed in U.S. Pat. No. 5,743,960, incorporated herein by reference. These typically use pick-and-place (“suck-and-spit”) fluid handling systems, whereby a quantity of fluid is aspirated from a source and dispensed onto a target for testing or further processing. In many cases, for example high throughput screening (HTS) and genomics, it is desirable and efficient to be able to both sequentially and simultaneously perform multiple dispense and/or aspirate functions, for example, to create an array of probes on a glass slide or biochip device. As indicated, to efficiently and accurately perform aspirate and dispense operations when dealing with microfluidic quantities of fluid can be a very difficult task. The complexity of this task is further exacerbated when multiple dispense/aspirate functions are performed.

One way in which the prior art accomplishes this is by utilizing multiple individual dispense systems, such as disclosed in U.S. Pat. No. 5,743,960, to form a line or array of dispensers. Each dispenser is hydraulically coupled to a pressurized reservoir or pump which serves as the driving function for forcing liquid through a tube, typically having a nozzle at one end, connected to the dispenser. This can be favorable in some situations, such as when dispensing large quantities of a different reagent through each dispenser. In other situations, for example when dispensing the same reagent at multiple locations, the use of multiple individual dispensers can greatly add to the system cost. Moreover, each individual dispenser has to be independently monitored, controlled and operated, and this can undesirably add to the complexity of the dispense and/or aspirate functions.

U.S. Pat. No. 4,952,518 discloses a machine for transferring liquids to and from the wells of assay trays. The machine includes a plurality of liquid dispensing manifolds and an aspirating manifold. Though such a machine can provide multi-channel dispensing/aspirating while maintaining relatively low cost and simplicity of operation, it is prone to imprecise dispensing (and aspirating) resulting in inaccurate, unreliable and unrepeatable performance. This is especially true when dealing with microfluidic quantities, typically less than about 50 microliters (μL), of fluids.

Thus, it would be desirable to provide a simple and inexpensive multi-channel dispense/aspirate system that provides accurate, reliable and repeatable dispensing and/or aspiration of microfluidic quantities of fluid.

### SUMMARY OF THE INVENTION

A multi-channel dispensing system constructed in accordance with one preferred embodiment of the present invention overcomes some or all of the afore-mentioned disadvantages by substantially negating and/or controlling the undesirable effects of flow resistance (impedance) on multi-channel dispensing operations. The system generally includes a multi-channel manifold in hydraulic communication with and intermediate a direct current fluid source and a plurality of dispensers. Advantageously, the droplet size, droplet frequency and flow rate of fluid emanating through each of the manifold channels can be controlled by actuations of the direct current fluid source and the drop-on-demand valves. The multi-channel dispensing system can also be used to aspirate (“suck”) quantities of reagent or other liquids from one or more fluid-containing sources/reservoirs.

In accordance with one embodiment, the present invention provides a multichannel system for aspirating or dispensing precise and/or predetermined microfluidic quantities of a fluid. The manifold system generally comprises a plurality of valves, a direct current fluid source and a manifold. The valves are adapted to be opened and closed at a predetermined frequency and duty cycle. The direct current fluid source is in hydraulic communication with the valves for metering predetermined quantities of the fluid to the valves. The manifold is positioned intermediate the plurality of valves and the direct current fluid source and includes a plurality of channels in hydraulic communication with a respective one of the valves.

In accordance with another embodiment, the present invention provides a system for aspirating generally precise and/or predetermined microfluidic quantities of one or more fluids from one or more fluid sources and dispensing precise and/or predetermined microfluidic quantities of the one or more fluids to one or more targets. The manifold system generally comprises a plurality of valves, a plurality of nozzles, a positive displacement pump, a manifold and a controller. The valves are adapted to be opened and closed at a predetermined frequency and duty cycle. The nozzles are coupled to a respective one of the valves and are adapted to be immersed in the one or more fluid sources. The positive displacement pump is in hydraulic communication with the valves for drawing predetermined quantities of the one or more fluids from the one or more fluid sources, and providing predetermined quantities of the one or more fluids to the one or more targets. The manifold is positioned intermediate the plurality of valves and the positive displacement pump, and includes a plurality of channels in hydraulic communication with a respective one of the valves. The controller individually controls the frequency/duty cycle of the valves to achieve balanced output and/or to achieve individual or sequential aspirating/dispensing of precise and/or predetermined quantities of the one or more fluids.

In accordance with another embodiment, the present invention provides an apparatus for dispensing and aspirating one or more fluids. The apparatus generally comprises a plurality of dispensers, a direct current fluid source, a manifold and controlling means. The direct current fluid source is in hydraulic communication with the plurality of dispensers for metering predetermined quantities of the one or more fluids to or from one or more of the dispensers. The manifold is positioned intermediate the plurality of dispensers and the direct current fluid source, and includes a plurality of channels in hydraulic communication with a respective one of the plurality of dispensers. The controlling means control each dispenser to achieve balanced output and/or to achieve individual or sequential dispensing/aspirating of precise and/or predetermined quantities of the one or more fluids.

In accordance with a further embodiment, a system for dispensing and aspirating predetermined quantities of one or more reagents is provided. The system generally comprises a plurality of dispensers, a positive displacement syringe pump, a manifold, and one or more pressure sensors. Each one of the plurality of dispensers includes a respective one of a plurality of drop-on-demand valves. The drop-on-demand valves are adapted to be opened and closed at a predetermined frequency and duty cycle. Each one of the plurality of drop-on-demand valves is in communication with a respective one of a plurality of nozzles for dispensing droplets of the reagent(s) onto one or more targets or for aspirating reagent(s) from one or more sources. The positive displacement syringe pump is in hydraulic communication with the drop-on-demand valves. The positive displacement pump includes a stepper motor adapted to decrement or increment a plunger of the positive displacement syringe pump for metering predetermined quantities of reagent(s) to or from said dispensers. The manifold is positioned intermediate the plurality of dispensers and the positive displacement syringe pump and is in hydraulic communication with the dispensers and the positive displacement syringe pump. The manifold includes a supply rail and a plurality of channels in hydraulic communication with a respective one of the plurality of drop-on-demand valves to form an (1×N) array of channels for dispensing or aspirating reagent(s). The pressure sensor(s) is/are placed intermediate the manifold and the positive displacement syringe pump and/or at the manifold and/or at one or more of the dispensers. Accordingly, the system can provide controlled and/or generally equal quantities and/or flow rates of reagent(s) to or from one or more of the plurality of dispensers.

In accordance with another embodiment a method for substantially balanced multi-channel dispensing is provided. The method includes the step of providing a plurality of dispensers which are connected to a common supply manifold and include a plurality of valves. A pump is provided in series with the manifold. The pump is actuated to displace a predetermined quantity of fluid. One or more of the dispensers are actuated to provide a quantity or quantities of the fluid to a target. The duty cycle and/or frequency of one or more of the valves is controlled to achieve substantially balanced flow.

In accordance with another embodiment a method for sequentially dispensing a fluid is provided. The method includes the step of providing a plurality of dispensers which are connected to a common supply manifold and include a plurality of valves. A direct current fluid source is provided in series with the manifold. The direct current fluid source is actuated to sequentially or continuously displace predetermined quantities of fluid. The dispensers are sequentially/individually actuated at predetermined intervals to provide a quantity or quantities of the fluid to one or more targets.

In accordance with another preferred embodiment of the present invention a hydraulic system is provided for sequentially dispensing precise and/or predetermined quantities of a fluid. The hydraulic system generally comprises a plurality of dispensers and a direct current fluid source. The dispensers are connected to a common supply manifold and include a plurality of valves adapted to be activated at predetermined intervals. The direct current fluid source is in fluid communication with the manifold.

The output fluid flow rate (Qₙ) through each one of the valves of the hydraulic system may be characterized by a transfer function having the general form:

$$\frac{{Q}_{n}}{{Q}_{t}} = \frac{\frac{K}{s ( s + \frac{1}{τ} )}}{1 + \frac{K}{s ( s + \frac{1}{τ} )}} = \frac{1}{1 + \frac{1}{K} s ( s + \frac{1}{τ} )}$$

with a characteristic equation given by:

$$1 + \frac{K}{s ( s + \frac{1}{τ} )} = 0$$

and a gain K given by:

$$K = \frac{1}{{R}_{t} C τ}$$

where, Qₜ is the input fluid flow rate provided by the direct current fluid source to each one of the valves, Rₜ is the flow resistance, C is the elastic capacitance, τ is the inertial or inductive time constant, and s is the Laplacian variable.

For purposes of summarizing the invention and the advantages achieved over the prior art, certain objects and advantages of the invention have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

FIG. 1 is a simplified schematic drawing of a dispensing manifold as is known in the prior art;

FIG. 2 is a graphical illustration of the effect of capillary radius on the capillary flow resistance;

FIG. 3 is a graphical illustration of the effect of orifice radius on the orifice flow resistance;

FIG. 4 is a simplified schematic illustration of a multi-channel dispensing system in accordance with one preferred embodiment of the present invention;

FIG. 5 is a cross-sectional detail view of the syringe pump of FIG. 4;

FIG. 6 is a schematic illustration of a solenoid valve dispenser for use in the multi-channel dispensing system of FIG. 4;

FIG. 7 is a simplified fluid circuit schematic of a single-channel positive displacement dispense system or the multi-channel dispensing system of FIG. 4 in series operation;

FIG. 8 is an electrical circuit analogue representation of the system of FIG. 7 or the multi-channel dispensing system of FIG. 4 in series operation;

FIG. 9A is a control block diagram representation of the system of FIG. 7 or the multi-channel dispensing system of FIG. 4 in series operation;

FIG. 9B is a simplified version of the control block diagram of FIG. 9A;

FIG. 9C is a root-locus diagram of the system of FIG. 7 or the multi-channel dispensing system of FIG. 4 in series operation;

FIG. 10 is a schematic of a multi-channel dispensing system including a one-dimensional array of dispensing channels and a direct current fluid source;

FIG. 11 is a schematic of a multi-channel dispensing system including a two-dimensional array of dispensing channels and a one-dimensional array of direct current fluid sources;

FIG. 12 is a schematic of multi-channel dispensing system including a two-dimensional array of dispensing channels and a direct current fluid source; and

FIG. 13 is a simplified electrical circuit analogue representation of the multi-channel dispensing system of FIG. 4 in parallel operation.

### DETAILED DESCRIPTION OF THE PREFERRED EMBODIMENTS

As outlined above, U.S. Pat. No. 4,952,518 discloses a machine for transferring liquids to and from the wells of assay trays. The machine includes a plurality of liquid dispensing manifolds for dispensing liquids into the tray wells and an aspirating manifold for aspirating liquid from the wells. Each dispensing manifold is equipped with a row of dispensing tubes and is connected via a pump to a liquid container. The aspirating manifold is equipped with a row of aspirating tubes and is connected via a pump to a waste liquid receptacle.

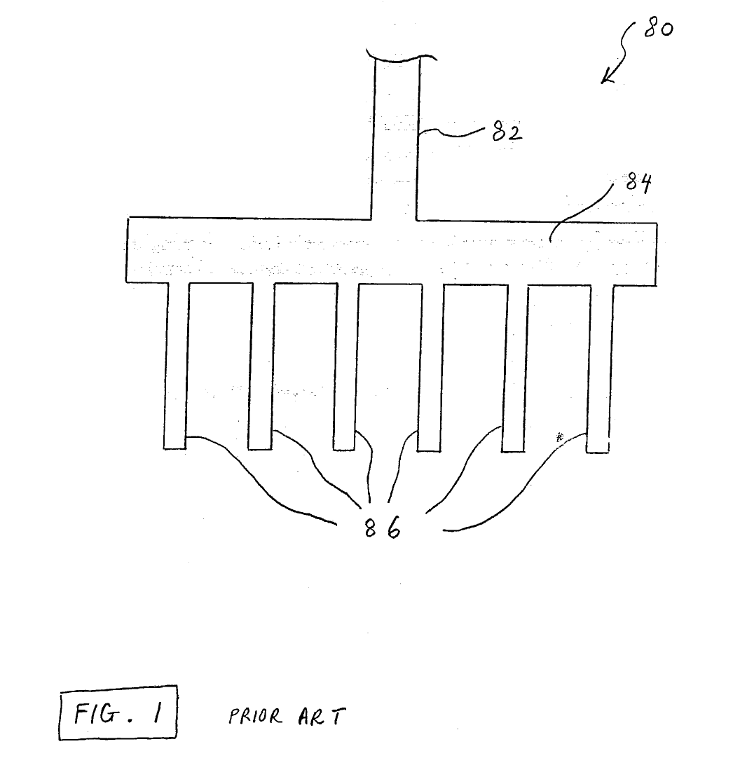

FIG. 1 is a simplified schematic drawing of a dispensing manifold 80 as disclosed in U.S. Pat. No. 4,952,518. The manifold 80 includes a chamber 84 connected to a row of dispensing tubes 86 and is in fluid communication with a conduit 82. In typical operation, the manifold 80 is utilized to simultaneously (in parallel) dispense liquid through each of the dispensing tubes 86. As suggested before, the use of such a dispensing manifold 80 can result in imprecise quantities of liquid to be dispensed, especially when dealing with microfluidic quantities.

This is because the amount of fluid ejected through each dispensing tube 86 (FIG. 1) will largely be dependent on the magnitude of the flow resistance/inductance (impedance) encountered along the various fluid paths. This flow resistance includes the effects of both capillary and orifice flow resistance. The fluid generally prefers to follow the path of least resistance.

Capillary flow resistance is dependent, among other factors, on the radius of the capillary and the length of the fluid path through generally straight sections of the capillary. Orifice flow resistance is determined, among other factors, by the area (radius) of the orifice the liquid flows through and also on the directional changes in the fluid path.

Differences in the internal dimensions, such as the internal radii, between the dispensing tubes 86 (FIG. 1) can cause variations in the flow resistances (impedances).

These dimensional variations are possible especially when small microfluidic quantities of fluid are being handled/transferred since this generally demands small internal dimensions with even smaller manufacturing tolerances. Moreover, the flow resistances (impedances) can change over time due to temperature effects, for example, on the dimensions and surface characteristics of the dispensing tubes 86 (FIG. 1). Additionally, there may be build up of crud or contaminants inside the dispensing tubes 86 (FIG. 1) which can also affect their flow resistances (impedances).

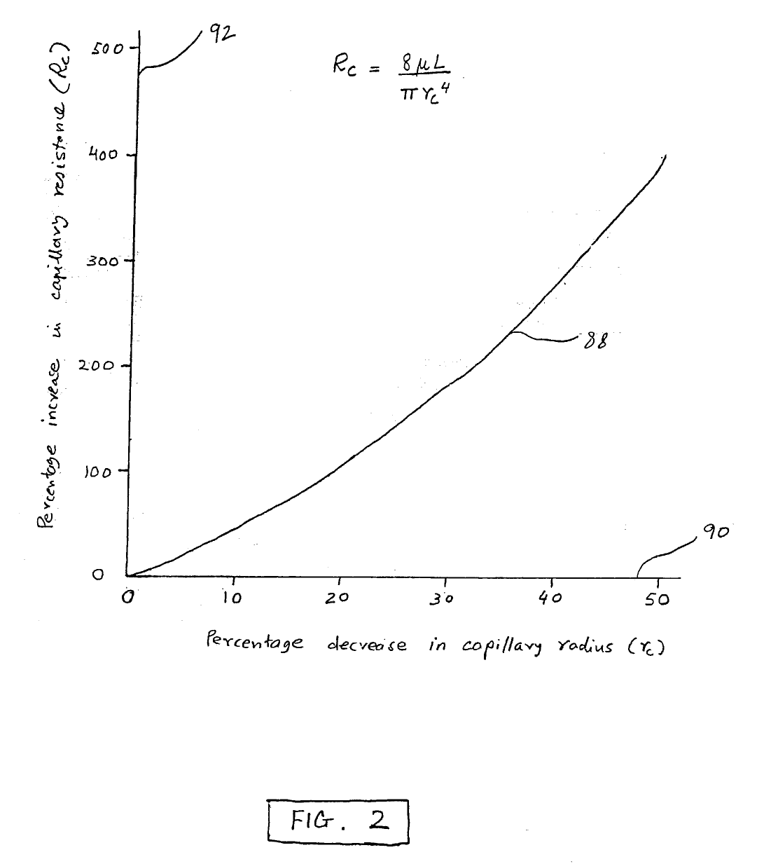

Line 88 in FIG. 2 graphically depicts the effect of variations in capillary radius (r_{c}) on the capillary flow resistance (R_{c}), for generally laminar flow. The x-axis 90 represents the percentage decrease in capillary radius (r_{c}) and the y-axis 92 represents the corresponding percentage increase in capillary flow resistance (R_{c}). As can be seen from FIG. 2, even about a 20% decrease in the capillary radius (r_{c}) can lead to an increase in the capillary flow resistance (R_{c}) of greater than about 100%.

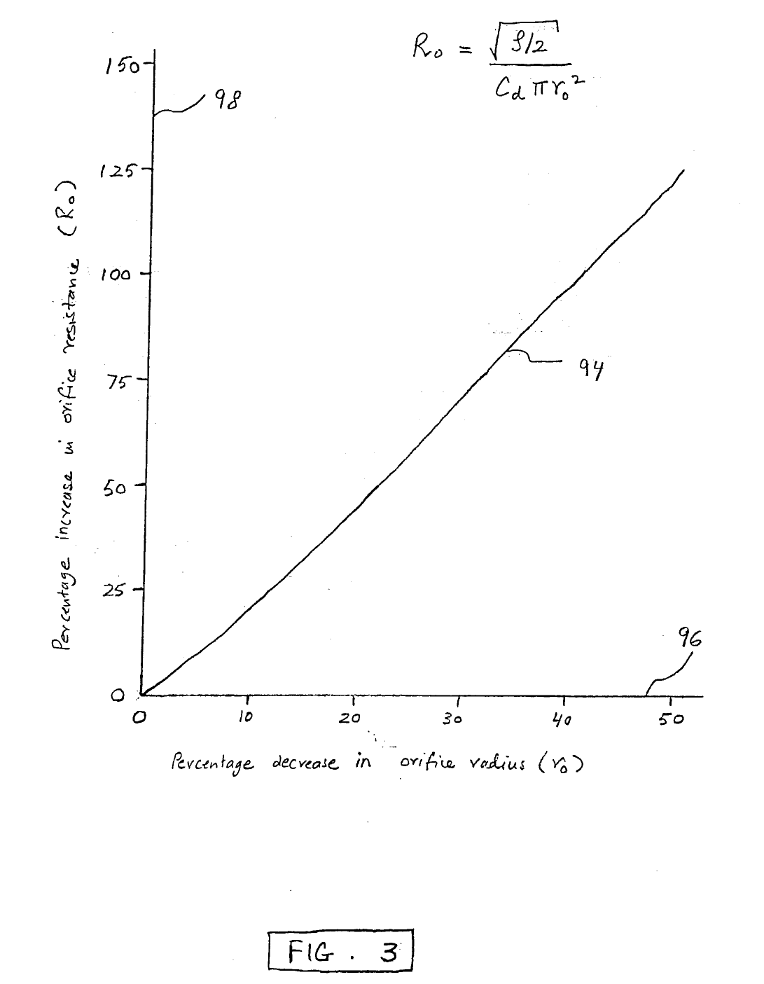

Similarly, line 94 in FIG. 3 graphically depicts the effect of variations in orifice radius (rₒ) on the orifice flow resistance (Rₒ), for generally laminar flow. The x-axis 96 represents the percentage decrease in orifice radius (r_{c}) and the y-axis 98 represents the corresponding percentage increase in orifice flow resistance (R_{c}). Referring to FIG. 3, even about a 20% decrease in the orifice radius (rₒ) can lead to an increase in the orifice flow resistance (Rₒ) of greater than about 40%.

In turn, these differences in flow resistances (impedances) can significantly affect the output of fluid through each dispensing tube 86 (FIG. 1). This is especially true in the case of simultaneous (parallel) dispensing through the dispensing tubes 86 (FIG. 1), as is disclosed in U.S. Pat. No. 4,952,518.

Multi-Channel Dispensing System

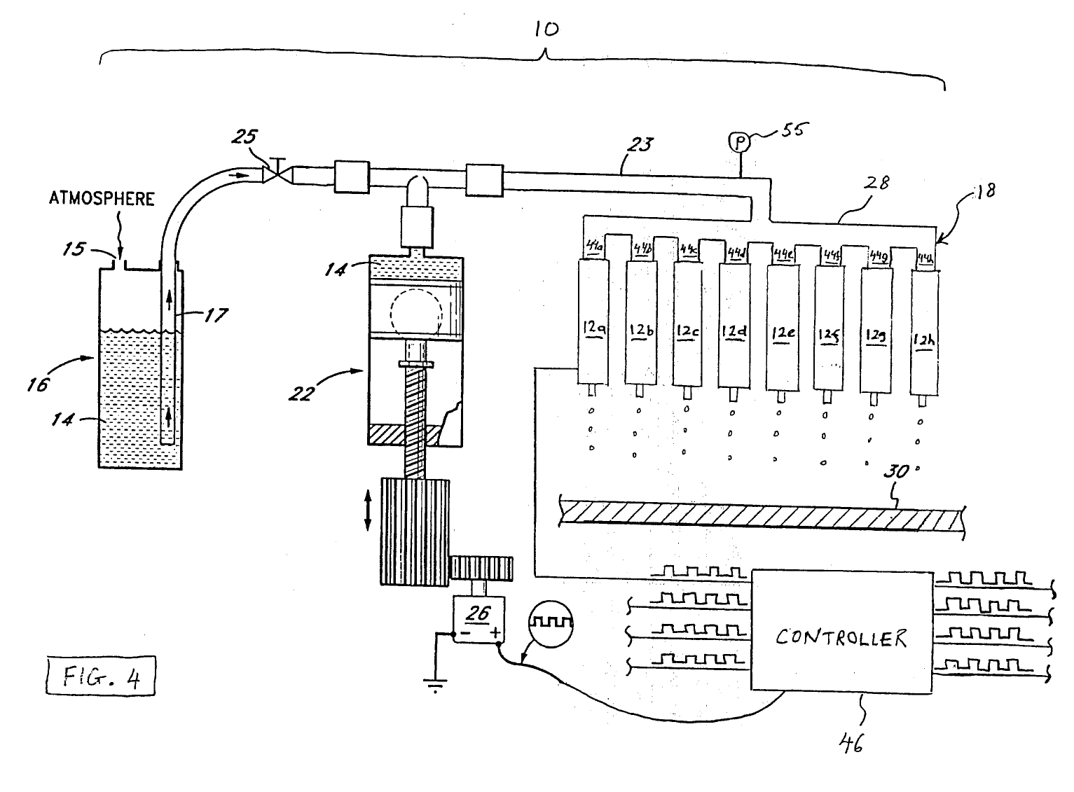

FIG. 4 is a schematic drawing of one preferred embodiment of a microfluidic multi-channel dispensing/aspirating system or apparatus 10 having features in accordance with the present invention. The system 10 overcomes some or all of the above limitations by substantially negating and/or controlling the undesirable effects of flow resistance on multi-channel dispensing operations.

The multi-channel dispensing system 10 (FIG. 4) generally comprises a multi-channel manifold 18 coupled to a plurality of dispensers 12 (labeled 12a to 12h) and a positive displacement syringe pump 22 intermediate a reservoir 16 containing fluid or reagent 14. The manifold 18 includes a supply line or rail 28 feeding into multiple independent channels 44 (labeled 44a to 44h) with each manifold channel 44a to 44h being in fluid communication with a respective one of the dispensers 12a to 12h. As discussed in greater detail later herein, each dispenser 12 is used to dispense a precise and/or predetermined quantity, in the form of droplets or a spray pattern, of fluid 14 onto or into a target 30. The dispense function is typically performed at a predetermined system pressure, and preferably at a steady state pressure. Each dispenser 12 may also be used to aspirate or “suck” a precise and/or predetermined quantity of fluid from one or more sources or reservoirs by creating a negative pressure or partial vacuum in the system.

Referring to FIG. 4, the pump 22 is preferably a high-resolution, positive displacement syringe pump hydraulically coupled to the dispensers 12. Alternatively, the pump 22 may be any one of several varieties of commercially available pumping devices for metering precise quantities of liquid. A syringe-type pump 22, as shown in FIG. 4, is preferred because of its convenience and commercial availability. A wide variety of other direct current fluid source means may also be used, however, to achieve the benefits and advantages as disclosed herein. These may include, without limitation, rotary pumps, peristaltic pumps, squash-plate pumps, and the like, or a pressurized fluid source electronically regulated to provide a current source pseudo effect.

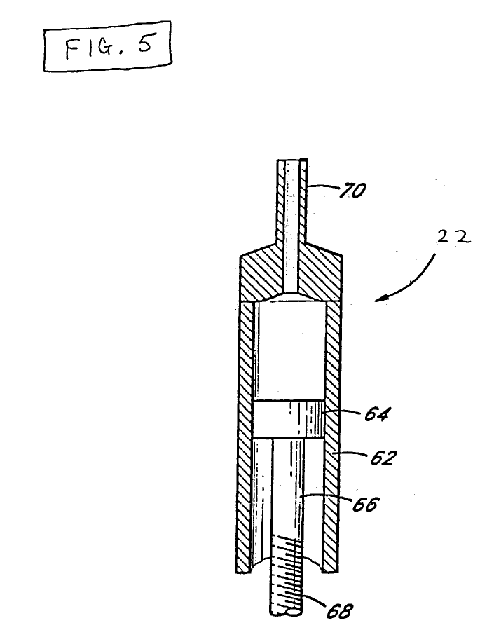

As illustrated in more detail in FIG. 5, the syringe pump 22 generally comprises a syringe housing 62 of a predetermined volume and a plunger 64 which is sealed against the syringe housing by O-rings or the like. The plunger 64 mechanically engages a plunger shaft 66 having a lead screw portion 68 adapted to thread in and out of a base support (not shown). Those skilled in the art will readily appreciate that as the lead screw portion 68 of the plunger shaft 66 is rotated the plunger 64 will be displaced axially. The plunger 64 can be incremented (displaced axially in the forward direction) to force fluid from the syringe housing 62 into the exit tube 70. Alternatively, the plunger 64 can be decremented (displaced axially in the reverse direction) to draw fluid from the exit tube 70 into the syringe housing 62. Any number of suitable motors or mechanical actuators may be used to drive the lead screw 68. Preferably, a stepper motor 26 (FIG. 4) or other incremental or continuous actuator device is used so that the amount and/or flow rate of fluid or reagent can be precisely regulated.

Referring to FIG. 4, the syringe pump 22 is connected to the reservoir 16 and the dispenser 12 through the main feedline 23 using, for example, Teflon tubing provided with luer-type fittings for connection to the syringe pump 22 and the dispenser manifold 18.

Various shut-off valves 25 and check valves (not shown) may also be used, as desired or needed, to direct the flow of fluid 14 to and/or from the reservoir 16, syringe pump 22 and dispenser manifold 18.

The fluid or reagent reservoir 16 (FIG. 4) may be any one of a number of suitable receptacles capable of allowing the fluid 14 to be siphoned into pump 22. The reservoir may be pressurized, as desired, but is preferably vented to the atmosphere, as shown, via a vent opening 15. The particular size and shape of the reservoir 16 is relatively unimportant. A siphon tube 17 extends downward into the reservoir 16 to a desired depth sufficient to allow siphoning of fluid 14. Preferably, the siphon tube 17 extends as deep as possible into the reservoir 16 without causing blockage of the lower inlet portion of the tube 17. Optionally, the lower inlet portion of the tube. 17 may be cut at an angle or have other features as necessary or desirable to provide consistent and reliable siphoning of fluid 14.

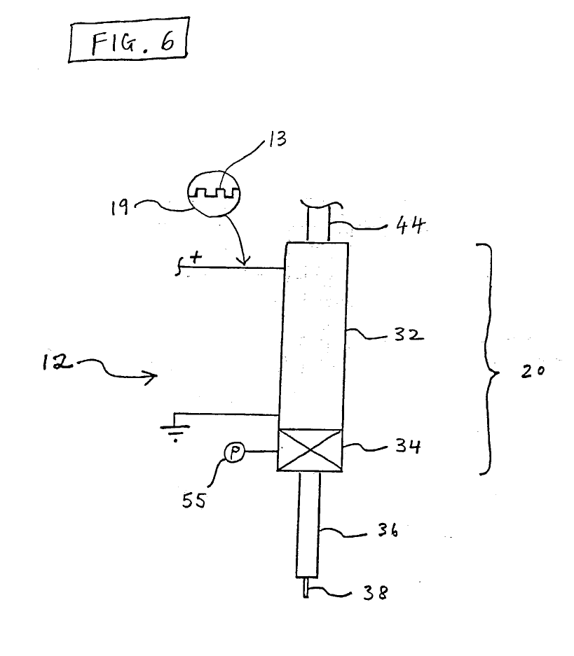

The dispensers 12 (FIG. 4) may be any one of a number of dispensers well known in the art for dispensing a liquid, such as solenoid valve dispensers, piezoelectric dispensers, aerosol dispensers, magneto-constriction dispensers, fluid impulse dispensers, heat actuated dispensers, or the like. In one form of the present invention a solenoid dispenser 12, schematically illustrated in FIG. 6, is preferred. Referring to FIG. 6, the solenoid valve dispenser 12 generally comprises a solenoid-actuated drop-on-demand valve 20, including a valve portion 34 and a solenoid actuator 32, coupled to a tube or tip 36 and a drop-forming nozzle 38. Each dispenser 12a to 12h is in fluid communication with a respective one of the manifold channels 44a to 44h (FIG. 4). The solenoid valves 20 are energized by one or more electrical pulses 13 provided by a pulse generator 19. When the valves 20 are open they are hydraulically coupled to or in fluid communication with a respective one of the tips 36 and nozzles 38. A detailed description of one typical solenoid valve dispenser can be found in U.S. Pat. No. 5,743,960, incorporated herein by reference.

Referring to FIG. 4, the supply rail 28 of the manifold 18 is in fluid communication with the main feedline 23. The manifold channels 44a to 44h are connected to the respective dispensers 12a to 12h utilizing, for example, luer-type fittings. Preferably, the manifold supply rail 28 and the manifold channels 44 are fabricated from a flexible tubing, such as Teflon tubing, and are coupled utilizing luer-type fittings. Of course, alternate materials and connecting means may be utilized with efficacy, as required or desired, giving due consideration to the goal of providing an inert, sealed, lightweight fluid conduit. For example, the manifold 18 may be fabricated as an integral unit from a rigid material, such as a lightweight thermoplastic. Alternatively, the manifold supply rail 28 may be rigid and one or more of the manifold channels 44a to 44h may comprise flexible tubing, or vice versa.

The manifold 18 (FIG. 4) of the dispensing system 10 may be sized and dimensioned in correspondence with the particular application. Preferably, the internal diameters of the manifold 18 are selected so that the flow resistance through the manifold supply rail 28 is very small relative to the flow resistances through the manifold channels 44 and the dispensers 12. In one embodiment, the manifold supply rail 28 has an internal diameter of about 1 to 5 mm and the channels 44 have an internal diameter of about less than 1 mm. Advantageously, the operation of the multi-channel dispensing system 10 is generally insensitive to the lengths of the supply rail 28 and the channels 44, as discussed at greater detail later herein. Typically, all the dispensers 12 (FIG. 4), and hence their respective drop-on-demand valves 20 (FIG. 6), tips 36 (FIG. 6) and nozzles 38 (FIG. 6), are similarly configured and dimensioned, though they may be configured and/or dimensioned as required or desired, giving due consideration to the goals of providing reliable and accurate dispensing and/or aspirating. The spacing and arrangement of the dispensers 12, and hence the manifold channels 44, is dictated by the particular application. The dispensers 12 may be arranged symmetrically or asymmetrically in a line, curve, circle, rectangle, and combinations thereof among other regular or irregular configurations, as required or desired, with efficacy.

The multi-channel dispensing system 10 (FIG. 4) may be maneuvered in several ways. A robot arm can be used to provide relative displacement between the system 10 and the target 30 and/or reagent aspiration source. Also, one or more robot arms may be used to maneuver one or more of the dispensers 12 (FIG. 4) to a required or desired location. Alternatively, the multi-channel dispensing system 10 and/or the target 30 and/or the fluid aspiration source may be mounted on movable X, X-Y or X-Y-Z platforms. The movable platforms can also be used in combination with one or more robot arms, as required or desired, to achieve one or more of the benefits and advantages as taught herein. An automated feedback control system may also be used in conjunction with the present invention to monitor and control the actuations of the syringe pump 22 (FIG. 4), the valves 20 (FIG. 6), the movable platforms and other associated components. As schematically illustrated in FIG. 4, a controller 46 may be utilized with the present invention to provide open-loop or closed-loop feedback control.

In one embodiment (series operation), the multi-channel dispensing system 10 (FIG. 4) is operated by sequentially opening the valves 20 (FIG. 6) to dispense fluid sequentially/individually through each manifold channel 44 (FIG. 4). In another embodiment (parallel operation), the multi-channel dispensing system 10 (FIG. 4) is operated by simultaneously opening the valves 20 (FIG. 6) to dispense fluid simultaneously through each manifold channel 44 (FIG. 4). Alternatively, a combined series-parallel procedure may be employed, as required or desired, with efficacy.

Those skilled in the art will recognize that the hydraulic coupling between the pump 22 and the dispensers 12 provides for the situation where the input from the pump 22 exactly equals the total output from one or more of the dispensers 12 under steady state conditions. This is true for both sequential (series) and simultaneous (parallel) operation.

Therefore, the positive displacement system uniquely determines the output volume of the system while the operational dynamics of the dispensers 12 serve to transform the output volume into ejected drop(s) having size, frequency and velocity.

It has been discovered, however, that within the multi-channel dispensing/aspirating system 10 (FIG. 4) there exists an elastic compliance partly due to the compliance in the delivery tubing and other connectors and components, and partly due to gaseous air bubbles that may have precipitated from air or other gases dissolved in the system fluid. As a result of this elastic compliance, initial efforts to dispense small quantities of fluid resulted in gradually overcoming the system compliance and not in dispensing fluid or reagent. Once this elastic compliance was overcome, a steady state pressure was found to exist and accurate dispensing occurred thereafter. To understand this phenomenon and the features and advantages of the present invention, it is helpful to first discuss the theoretical predicted behavior and theoretical flow models relating to positive displacement dispensing and aspirating systems.

Positive Displacement Dispensing/Aspirating

The models included herein depict the basic theory of operation of a positive displacement dispense system. Of course, the models may also apply to other direct current fluid source dispensing devices for dispensing small quantities of fluid. These models examine the design and operation of the dispensing system from a mathematical, physical, circuit and block diagram perspective representation, with each perspective being equivalent but offering a distinct view of the system.

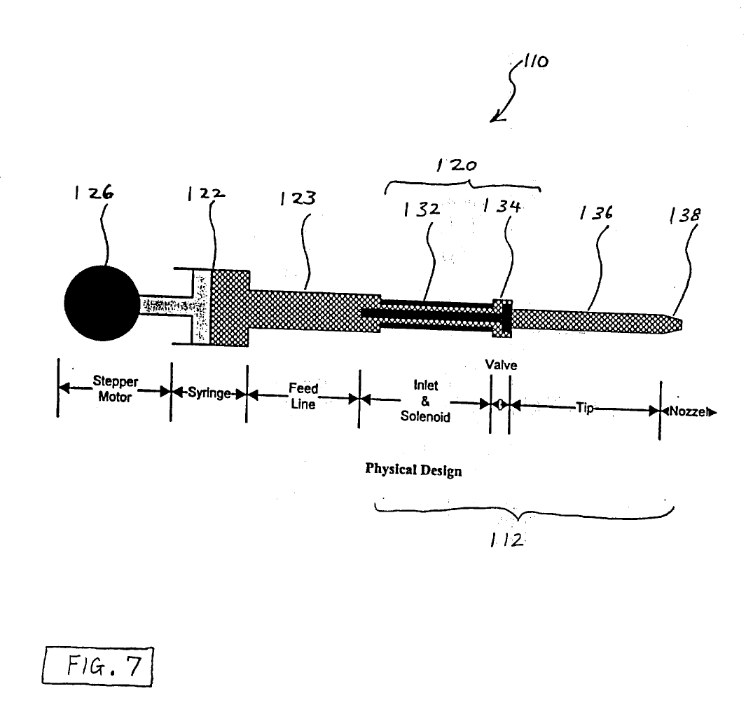

FIG. 7 is a simplified fluid circuit schematic drawing of a microfluidic dispense/aspirate system or apparatus 110. This fluid circuit schematic can represent a single-channel dispense system, such as the one disclosed in U.S. Pat. No. 5,743,960, incorporated herein by reference. The fluid circuit schematic of FIG. 7 can also represent the multi-channel dispense/aspirate system 10 (FIG. 4) operating in a sequential (series) mode, since only one of the multi-channel system's channel 44 (FIG. 4) and dispenser 12 are active at a given time in this mode.

Referring to FIG. 7, the dispense system 110 generally comprises a dispenser 112 and a positive displacement syringe pump 122 driven by a stepper motor 126. The syringe pump 122 is hydraulically coupled to the dispenser 112 via a feedline 123. The dispenser 112 includes a drop-on-demand valve 120, such as a solenoid-actuated valve with a solenoid actuator 132 and a valve portion 134. The valve 120 is coupled to a tube or tip 136 and a drop-forming nozzle 138. The positive displacement pump 122 meters the volume and/or flow rate of the reagent or fluid dispensed. The dispenser 112 is selectively operated to provide individual droplets or a spray pattern of reagent, as desired, at the predetermined incremental quantity or metered flow rate. The dispenser 112 may also be operated in an aspirate mode to “suck” reagent or other liquids from a fluid source.

As noted above, the positive displacement pump 122 is placed in series with the dispenser 112 (FIG. 7) has the benefit of forcing the dispenser 112 to admit and eject a quantity and/or flow rate of reagent as determined (under steady state conditions) solely by the positive displacement pump 122. In essence, the syringe pump 122 acts as a forcing function for the entire system, ensuring that the desired flow rate is maintained regardless of the duty cycle, frequency or other operating parameters of the dispensing valve, such as the solenoid-actuated valve 120. This is certainly true for steady state operation, as discussed in more detail below. However, for non-steady state operation, it has been discovered that the elastic capacitance of the feedline and precipitated gaseous bubbles in the system can cause transient changes in dispensing pressure and system behavior.

In fluid flow analysis, it is typical to represent the fluid circuit in terms of an equivalent electrical circuit because the visualization of the solution to the various flow and pressure equations is more apparent. The electrical circuit components used in this analysis include flow resistance (R), elastic capacitance (C) and inertial inductance (L). As is known in the art, the electrical equivalent of hydraulic pressure, P, is voltage and the electrical equivalent of flow or flow rate, Q, is current. The following defines the basic mathematical characteristics of the components.

Resistance

Flow resistance, R, is modeled as a resistor in the equivalent circuit and can be mathematically represented by the following:

$$\frac{\partial P}{\partial Q} = R \qquad ( 1 )$$

In the case of fluid flow, the resistance is usually nonlinear because of orifice constrictions which give rise to quadratic flow equations. This is further elaborated below. In the present analysis it is assumed that laminar flow conditions are present and that fluid flows through a circular cross section. There are two types of flow resistance: capillary and orifice. Capillary flow resistance applies to flow through sections of tubes and pipes. Orifice flow resistance applies to constrictions or changes in flow direction. Capillary resistance can be represented by the following:

Q=A\overline{u} (2)

$$\begin{matrix}{R}_{c} = \frac{Ω {L}_{c}}{{A}_{c}} & ( 3 ) \\ Ω = \frac{8 μ}{{r}^{2} c} & ( 4 )\end{matrix}$$

where, R_{c} is the capillary flow resistance, Q is the flow rate, A_{c} is the cross-sectional area, \overline{u} is the mean velocity of flow, Ω is the flow resistivity, L_{c} is the capillary length, μ is the viscosity, and r_{c} is the radius of the circular capillary.

Orifice resistance is represented as:

$$\begin{matrix}Q = \frac{\sqrt{Δ P}}{{R}_{o}} & ( 5 ) \\ {R}_{o} = \frac{\sqrt{ρ / 2}}{{A}_{o} {C}_{d}} & ( 6 )\end{matrix}$$

where, Rₒ is the orifice flow resistance, ρ is the fluid density, Aₒ is the cross-sectional area, and C_{d} is the discharge coefficient.

For a nozzle, the orifice constriction occurs at the entrance to the nozzle and the nozzle is a capillary (straight tube). This results in two resistances, orifice and capillary, in series. In general, the pressure and flow relationships in a system composed of a number of orifices and capillaries can be defined under these conditions as:

$$Δ P = \sum {R}_{o}^{2} {Q}^{2} + \sum {R}_{c} Q \qquad ( 7 )$$

where ΔP is the pressure drop, the quadratic term Rₒ²Q² is due to the orifice resistance, which depends on the fluid density, and the linear term R_{c}Q is due to the capillary resistance, which depends on the fluid viscosity. This suggests that for a given geometry it may be possible to measure these fluid properties (density and viscosity) by performing regression fits to pressure and flow data. In order to model the resistance, all the orifices and capillaries of the system need to be identified.

Inductance

In laminar fluid flow through capillaries, the fluid velocity profile is parabolic with zero velocity at the capillary wall and the maximum velocity at the center. The mean velocity \overline{u} is one half the maximum velocity. Since the fluid has mass and inertia, there is a time constant associated with the buildup of flow in the tube. This is modeled as an inductance in series with the resistance. The derivation of the inertial time constant, τ, is illustrated in Modeling Axisymmetric Flows, S. Middleman, Academic Press, 1995, Page 99, incorporated herein by reference. The time constant, τ, can be defined as:

$$τ = \frac{L}{{R}_{c}} = \frac{ρ {r}_{c}^{2}}{μ {a}_{1}^{2}} \qquad ( 8 )$$

where L is the inductance and a₁=2.403. Thus, the inertial inductance can easily be computed from the time constant, τ, and the capillary flow resistance, R_{c}.

Capacitance

The walls of the feedline, any precipitated gaseous bubbles in the fluid, and (to a very limited extent) the fluid itself are all elastic (compressible). This phenomenon gives rise to an elastic capacitance, where energy can be stored by virtue of the compression of the fluid and bubbles and/or the expansion of the feedline walls. The magnitude of the capacitance, C, can be found from the following equations:

Zₐ=ρCₛ (9)

$$\begin{matrix}{Z}_{ratio} = \frac{{Z}_{a}}{Ω L} & ( 10 ) \\ C = \frac{L}{{( {Z}_{ratio} {R}_{c} )}^{2}} & ( 11 )\end{matrix}$$

where, Zₐ is the acoustic impedance and Cₛ is the speed of sound. The speed of sound, Cₛ, accounts for the effects of fluid bulk modulus, wall elasticity, and elastic effects of any gas in the system. In the present modeling, the feedline is the major contributor to the elastic capacitance.

Physical Fluid Circuit Representation

The overall fluid circuit schematic construction of the positive displacement system 110 is shown in FIG. 7. As discussed before, the system 110 generally includes a stepper motor 126, a syringe pump 122, a feedline 123, and a drop-on-demand valve 120, with a solenoid actuator 132 and a valve portion 134, coupled to a tip 136 and a nozzle 138.

The syringe pump 122 (FIG. 7) of the system acts as a fluid current source and forces a given volume per step into the system. The force available from the stepper motor 126 (FIG. 7) is essentially infinite, due to the large gear ratio to the syringe input. The input is impeded from the forces feeding back from the system. Since volume, V, is the integral of the flow rate:

V=∫Qdt (12)

and the flow rate, Q, is modeled as current, the syringe pump is therefore a current source rather than a pressure (voltage) source. Since any impedance in series with a current source has no effect on the flow rate, this has the beneficial effect of removing the influence of the impedance of the feed line (resistance and inductance) on the flow rate. Advantageously, this solves a major problem that would be present if a pressure source were used as the driving function. For a pressure source, the feedline impedance would offer a changing and/or unpredictable resistance to flow and could give rise to hydraulic hammer pressure pulses and varying pressure drops across the feedline which could affect the flow rate through the dispense system, and hence the fluid output. By utilizing a current source, such as the syringe pump, the effect of changes in fluid impedance is substantially negligible or none on the flow rate, and thus accurate fluid volumes can be readily dispensed.

Electrical Circuit Analogue Representation

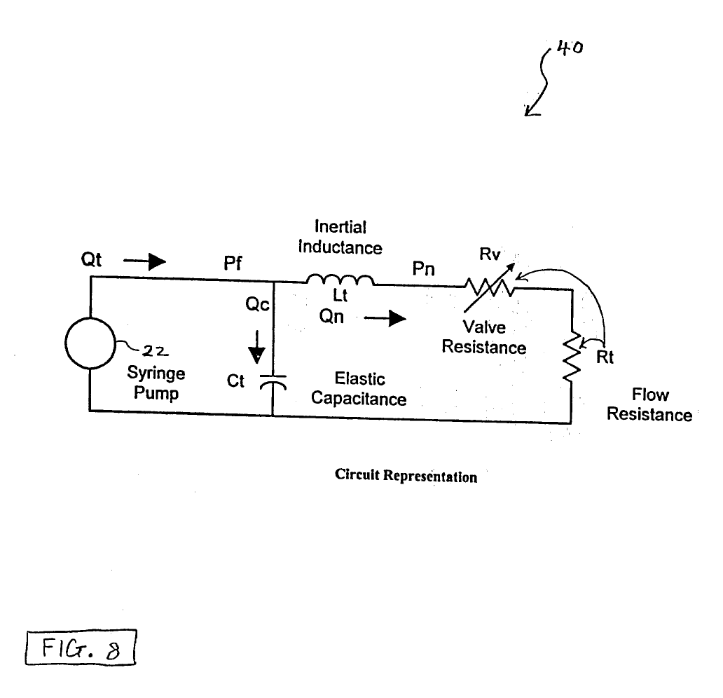

A simplified electrical circuit analogue representation 40 of the positive displacement dispense system 110 (FIG. 7) is shown in FIG. 8. The syringe pump 122 forces a total flow rate of Qₜ into the system. The flow is comprised of Q_{c} and Qₙ. Q_{c} is the flow that is driven into the elastic capacitance Cₜ of the system and Qₙ is the flow rate that is output from the nozzle 138 of the system. The inductance Lₜ and resistance Rₜ are the totals of all elements within the valve 120, tip 136, nozzle 138 and feedline 123. The valve resistance Rᵥ varies with the actuation displacement of the valve 120 during operation from forces applied by the solenoid actuator 132. When the valve 120 is closed, the valve resistance Rᵥ is infinite. The pressure in the feedline 123 is P_{f} and the pressure at the nozzle 138 is Pₙ.

Block Diagram Representation

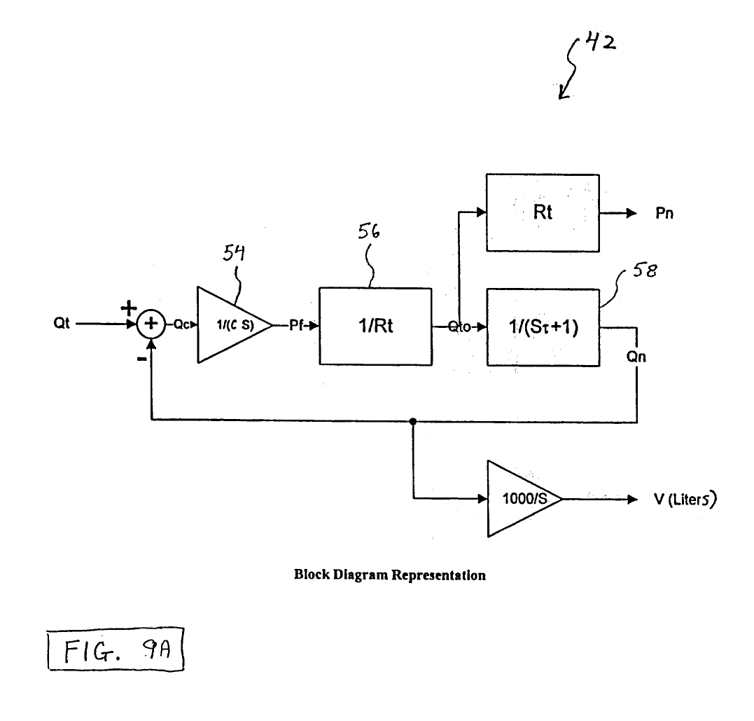

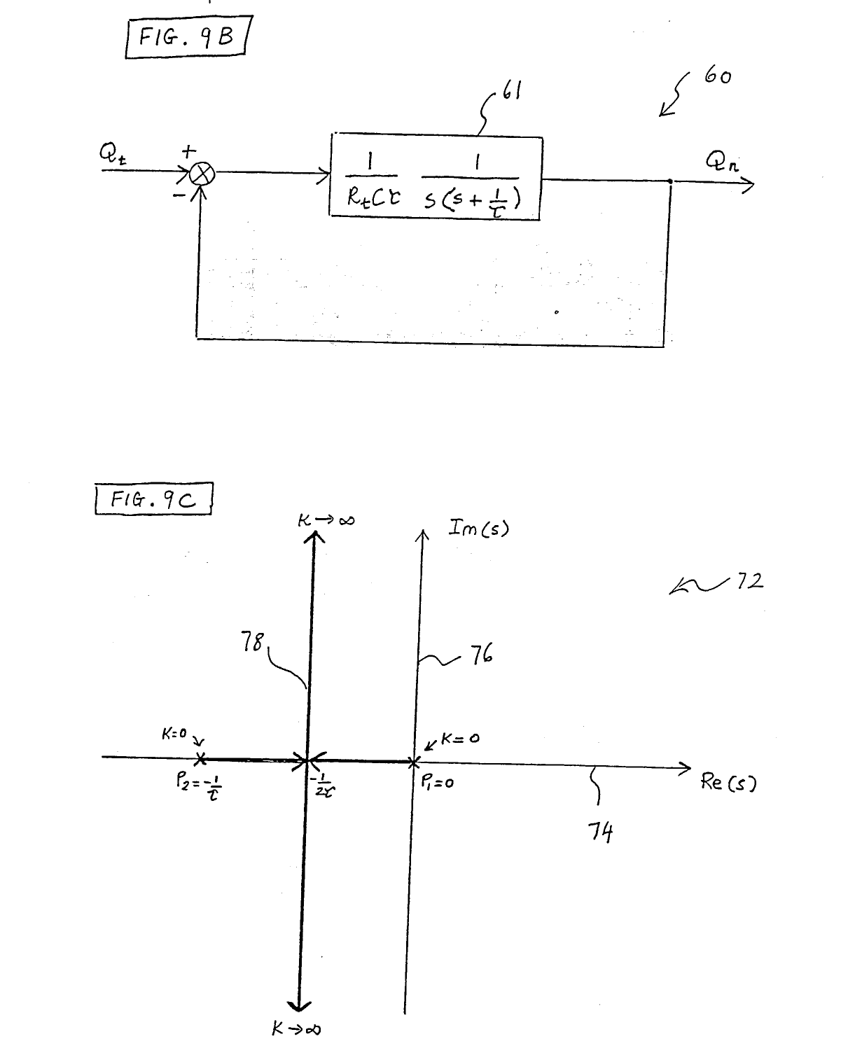

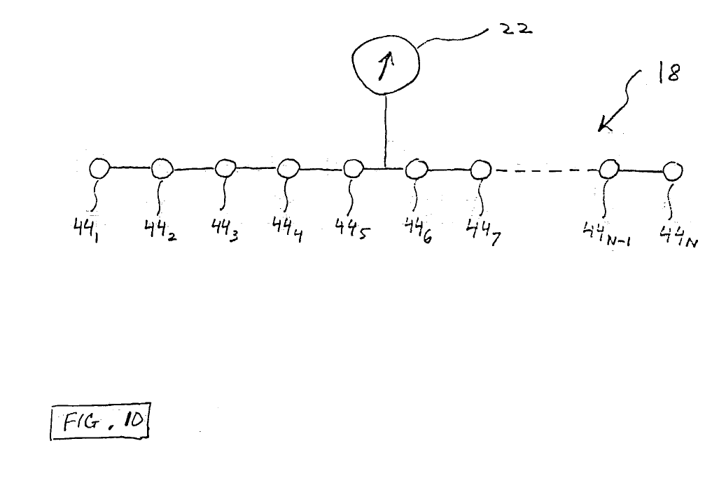

A block diagram or control system representation 42 of the positive displacement dispense system 110 (FIG. 7) is shown in FIG. 9A. This is perhaps the best way to see why the output fluid volume is synchronized to the syringe input. As can be seen from FIG. 9A, this block diagram model 42 represents a feedback loop, in which the difference between Qₜ and Qₙ drives the flow into the elastic capacitance, Q_{c}. If the flow out of the nozzle 138 is not exactly the same as the flow input, Qₜ, then the pressure in the feedline 123, P_{f}, will change. The feedback loop forces the value of P_{f} to be whatever is necessary, at steady state, to maintain the output flow rate, Qₙ, to equal the input flow rate, Qₜ. This is true regardless of the value of Rₜ. The inductive time constant is τ (in FIG. 9A) and the Laplacian Operator is s=jω.

The value of feedline pressure, P_{f}, will increase when the valve 20 (FIG. 7) is closed (Qₙ=0), since all the input flow will go into the elastic capacitance as Q_{c}. The use of a time constant in the block diagram 42 (FIG. 9A) simplifies the mathematical calculations when the valve has infinite resistance. Qualitatively similar results will be obtained if the block diagram 42 (FIG. 9A) is modeled in a form including the unreduced Laplacian formula for inductance (L) instead of the simplified time constant (τ).

The block diagram model 42 (FIG. 9A) indicates that the system has the potential for damped oscillations in flow. The elastic capacitance is an integrator and the inertial time constant, τ, in the loop can give rise to the possibility of underdamped oscillations in transient flow. These oscillations may show up in pressure readings in the feedline 123 (FIG. 7). The magnitude of the oscillations is dependent on the damping, which, in turn, is dependent on the flow resistance and the resonate frequency of the system.

The closed-loop transfer function of the control system 42 (FIG. 9A) may be generally stated as follows:

$$W ( s ) = \frac{G ( s )}{1 + G ( s ) H ( s )} \qquad ( 13 )$$

where:

W(s)=transfer function of the system expressed in the Laplace domain;

G(s)=forward transfer function; and

H(s)=feedback transfer function.

The forward transfer function G through blocks or control elements 54, 56, 58 (FIG. 9A) may be expressed as follows:

$$G ( s ) = \frac{1}{Cs} \frac{1}{{R}_{t}} \frac{1}{s τ + 1} = ( \frac{1}{{R}_{t} C τ} ) \frac{1}{s ( s + \frac{1}{τ} )} \qquad ( 14 )$$

By using equation (14), the control block diagram 42 (FIG. 9A) can also be represented by a simplified equivalent block diagram 60 (FIG. 9B) with a block element 61 (FIG. 9B). The control or block element 61 (FIG. 9B) incorporates the reduced forward transfer function of equation (14). The feedback transfer function H for the block diagram 42 (FIG. 9A) may be expressed as follows:

H(s)=1 (15)

Substituting equations (14) and (15) in equation (13), the unreduced closed-loop transfer function is expressed as:

$$W ( s ) = \frac{G ( s )}{1 + G ( s ) H ( s )} = \frac{{Q}_{n}}{{Q}_{t}} = \frac{( \frac{1}{{R}_{t} C τ} ) \frac{1}{s ( s + \frac{1}{τ} )}}{1 + ( \frac{1}{{R}_{t} C τ} ) \frac{1}{s ( s + \frac{1}{τ} )}} \qquad ( 16 )$$

Equation (16) can be simplified to yield the closed-loop transfer function in a reduced form, as shown below by equation (17):

$$W ( s ) = \frac{{Q}_{n}}{{Q}_{t}} = \frac{1}{1 + ( {R}_{t} C τ ) s ( s + \frac{1}{τ} )} \qquad ( 17 )$$

The characteristic equation of the control system is defined by setting the denominator of equation (16) equal to zero and is given by:

$$1 + ( \frac{1}{{R}_{t} C τ} ) \frac{1}{s ( s + \frac{1}{τ} )} = 0 \qquad ( 18 )$$

The zeros and poles of the characteristic equation can be determined by the expression:

$$K \frac{Z ( s )}{P ( s )} = G ( s ) H ( s ) = ( \frac{1}{{R}_{t} C τ} ) \frac{1}{s ( s + \frac{1}{τ} )} \qquad ( 19 )$$

where, K is the gain and Z(s) and P(s) are polynomials which yield the zeros and poles. The above characteristic equation (18) has no zeros (n_{z}=0) and two poles (nₚ=2) P₁=0 and P₂=−1/τ, where n_{z} is the number of zeros and nₚ is the number of poles. Also, the gain K of the system can be defined as:

$$K = \frac{1}{{R}_{t} C τ} \qquad ( 20 )$$

The characteristic equation (18) can be manipulated to give a quadratic equation (21):

$${s}^{2} + ( \frac{1}{τ} ) s + K = 0 \qquad ( 21 )$$

where K is the gain as defined above by the expression (20). Since equation (20) is a quadratic equation it has two roots which can be expressed as:

$${s}_{r} = - \frac{1}{2 τ} [ 1 \pm \sqrt{1 - 4 {τ}^{2} K} ] \qquad ( 22 )$$

These roots sᵣ determine the stability characteristics of the control system 42 (FIG. 9A). The nature of the roots sᵣ is dependent on the magnitude of the gain K=1/(RₜC_{τ}), or more specifically on the magnitude of the parameter (4τ²K=4τ/RₜC). Note that since the time constant (τ), the resistance (Rₜ), and the capacitance (C) are all positive real numbers, the parameter (4τ²K) is also a positive real number. The only exception to this is when the valve 20 (FIG. 1) is closed, and hence the resistance Rₜ is infinite which results in K=0, so that (4τ²K)=0.

For the case of 0<(4τ²K)≦1, it is easily deduced that the characteristic equation (18) or (21) has two real roots sᵣ<0. This indicates that the control system 42 (FIG. 9A) is unconditionally stable for 0<(4τ²K)≦1.

For the case of (4τ²K)>1, it is easily deduced that the characteristic equation (18) or (21) has two real complex conjugate roots sᵣ which have negative real parts. This indicates that the control system 42 (FIG. 9A) is unconditionally stable for (4τ²K)>1.

For the case of (4τ/RₜC)=0, that is when the valve 20 (FIG. 1) is closed and the resistance Rₜ is infinity (K=0), it is easily deduced that the characteristic equation (18) or (21) has two real roots sᵣ=0 and sᵣ<0. This indicates that the control system 42 (FIG. 9A) is limitedly stable for (4τ²K)=0 or K=0.

The above stability analysis shows that the control block representation 42 (FIG. 9A) of the positive displacement dispense system 110 (FIG. 7) is always stable. This is true as the parameter (4τ²K), or alternatively the gain K, is varied from zero to infinity.

Another popular technique for studying the stability characteristics of a control system involves sketching a root locus diagram of the roots of the characteristic equation as any single parameter, such as the gain K, is varied from zero to infinity. A discussion of the root locus method can be found in most control theory texts, for example, Introduction to Control System Analysis and Design, Hale, F. J., Prentice-Hall, Inc., 1973, Pages 137-164, incorporated herein by reference.

FIG. 9C shows a sketch of a root locus diagram 72 for the control system representation 42 (FIG. 9A). The root locus diagram 72 is plotted in the s-plane and includes a real axis 74, Re(s), an imaginary axis 76, Im(s), and a sketch of the root locus 78.

Typically, the determination of the root locus relies on a knowledge of the zeros and poles of the control system. As indicated above, the characteristic equation (18) of the control block diagram 42 (FIG. 9A) has no zeros (n_{z}=0) and two poles (nₚ=2). Thus, the root locus 78 (FIG. 9C) will have two branches and two zeros at infinity. On the real axis 74 (FIG. 9C), the root locus will exist only between the two poles P₁=0 and P₂=1/τ. Since there are two infinite zeros, there will be two asymptotes to the locus branches at angles given by:

$${θ}_{k} = \frac{( 2 k + 1 ) {180}^{∘}}{{n}_{p} - {n}_{z}} k = 0 , 1 \qquad ( 23 )$$

so that, θₖ=90°, 270°. The cg or intersection of the asymptotes and the real axis 74 (FIG. 9C) is given by:

$$c g = \frac{\sum poles - \sum zeros}{{n}_{p} - {n}_{z}} \qquad ( 24 )$$

so that, cg=−1/2τ. Since there are only two poles P₁ and P₂ on the real axis the breakaway point between the two poles, P₁=0 and P₂=−1/τ, is halfway between the poles, that is, at s=−1/2τ. Also, since two branches are leaving the breakaway point, the angles at breakaway are ±90°. This completes the sketch of the root locus 78 as shown in FIG. 9C.

The root locus 78 (FIG. 9C) begins at the poles P₁=0 and P₂=−1/τ with the gain K being equal to zero. The root locus 78 (FIG. 9C) then travels along the negative segment of the real axis 74 (FIG. 9C) while the value of K is incremented and converges at the breakaway point at s=−1/2τ. At the breakaway point the root locus 78 (FIG. 9C) branches, parallel to the imaginary axis 76 (FIG. 9C), towards the zeros at infinity with the gain K being further incremented until it reaches infinity.

It will be appreciated that the root locus 78 (FIG. 9C) represents all values of s in the Laplace domain for which the characteristic equation (18) is satisfied as the gain K is varied from zero to infinity. From the root locus diagram 72 (FIG. 9C) it may be observed that all of the roots (except the root at the pole P₁=0) lie on the left side of the imaginary axis 76 in the s-plane. This indicates that the system is unconditionally stable for all possible values of the gain K>0 and the system is limitedly stable when the gain K=0. Thus, the control system representation 42 (FIG. 9C) of the positive displacement dispense system 110 (FIG. 7) demonstrates stability for all values of K. This concurs with the above stability analysis based on the solution for the roots of the characteristic equation (18) or (20).

In general, the above control theory stability analysis for a positive displacement dispense system 110 (FIG. 7) can qualitatively apply to the multi-channel dispensing system 10 (FIG. 4) of the present invention, even when the latter is operating in parallel (simultaneous dispensing through more than one manifold channel). This is because both utilize direct current fluid source means and the flow resistances, elastic capacitances and inertial inductances of the multi-channel dispensing system 10 (FIG. 4), during parallel operation, may be collapsed to result in a control block diagram which is qualitatively similar to the one shown in FIG. 9A. But again this only indicates that, during parallel dispensing, the multi-channel dispensing system 10 (FIG. 4) of the present invention will provide generally stable performance and that the total fluid input will essentially equal the total fluid output. However, the stability analysis does not “actively” show how this fluid output is divided among the manifold channels. Under ideal conditions, in one embodiment, this fluid output should be equally divided among the dispensing nozzles 38 (FIG. 6). It is one object of this invention to provide means to actively control the distribution of this fluid output between the nozzles 38 (FIG. 6), and hence provide accurate controlled dispensing during parallel operation.

It was demonstrated above that providing a positive displacement pump 122 in series with a dispenser 112 (FIG. 7) has the benefit of forcing the dispenser 112 to admit and eject a quantity and/or flow rate of reagent as determined solely by the positive displacement pump 122 for steady state operation. In essence, the syringe pump 122 acts as a forcing function for the entire system, ensuring that the desired flow rate is maintained regardless of the duty cycle, frequency or other operating parameters of the dispensing valve, such as the solenoid-actuated valve 120 (FIG. 7). With such configuration and at steady state operation one does not really care what the pressure in the system is because it adjusts automatically to provide the desired flow rate by virtue of having a positive displacement or direct current fluid source as a forcing function for the entire system.

However, this does not address the situation of latent and/or transient pressure variations, such as associated with initial start-up of each dispense and aspirate function.

In particular, it has been discovered that the pressure in the system is of critical concern for non-steady state operation involving aspirating or dispensing of microfluidic quantities, typically less than about 50 microliters (μL), of reagent or other fluids. Specifically, for an aspirate function it has been discovered that a system pressure close to or below zero is most preferred, while for a dispense function it has been discovered that a finite and positive predetermined steady state pressure is most preferred. The transitions between various modes (aspirate, dispense, purge/wash) and/or flow rates or other operating parameters can result in pressure transients and/or undesirable latent pressure conditions within the positive displacement dispense/aspirate system. Purge and wash functions usually entail active dispensing in a non-target position. In some cases, when the same reagent is to be aspirated again, several aspirate-dispense cycles can be performed before executing a purge or wash function. Also, sometimes a purge function may have to be performed during a dispense function, for example, to alleviate clogging due to the precipitation of gaseous bubbles within the system and/or source fluid. The manner in which pressure compensation is provided prior to dispense and aspirate functions is discussed in detail later herein.

Other Embodiments

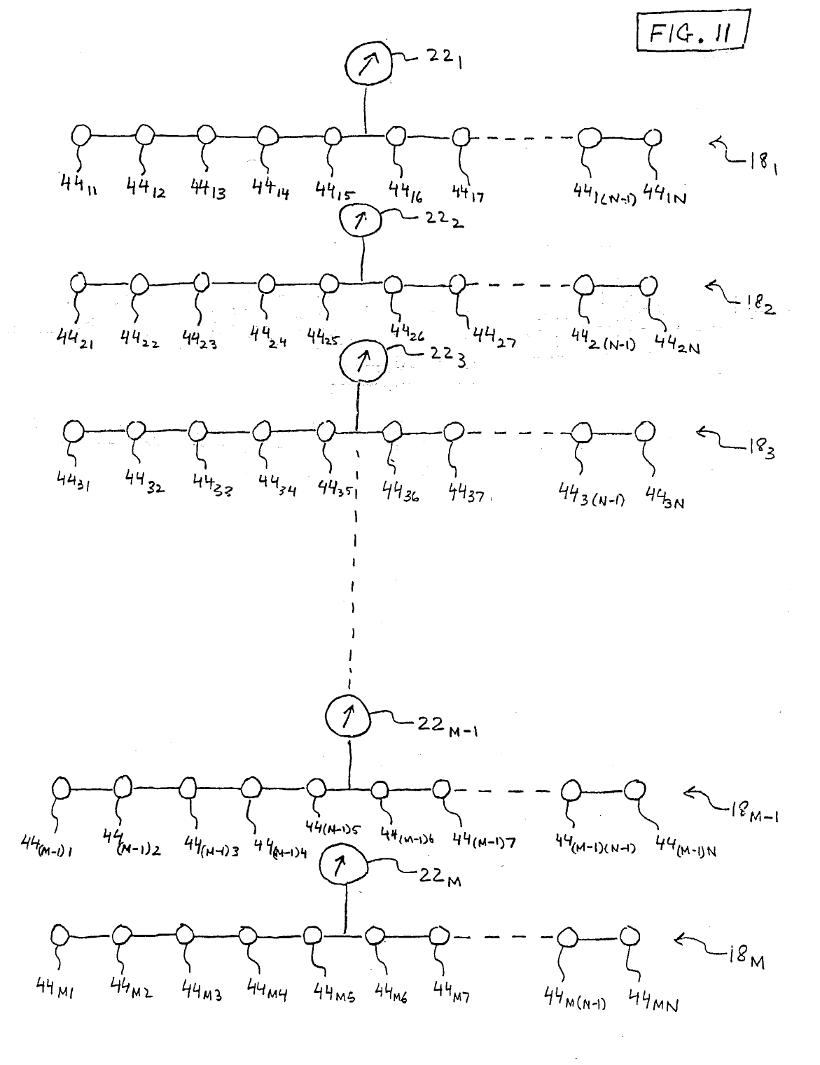

As schematically illustrated in FIG. 10, in one preferred embodiment of the present invention the manifold 18 is hydraulically coupled to a single positive displacement syringe pump 22. The manifold 18 is formed as a one-dimensional (1×N) array of channels 44, where N≧1 and the channels 44 are labeled as channels 44₁ to 44_{N}. In turn, each channel 44₁ to 44_{N} is in fluid communication with a respective one of N dispensers 12 (FIG. 4). Preferably, solenoid dispensers 12 (FIG. 6) are utilized in the multi-channel dispensing system, and hence the system will include N drop-on-demand solenoid-actuated valves 20 (FIG. 6).

More preferably, and as depicted in FIG. 4, the manifold 18 which is connected to the syringe pump 22 comprises a one-dimensional (1×8) array of channels 44. Each one of the eight channels 44a to 44h, in turn, is in fluid communication with a respective one of the eight dispensers 12a to 12h. Preferably, solenoid dispensers 12 (FIG. 6) are utilized in the multi-channel dispensing system 10 (FIG. 4), and hence the system will include eight drop-on-demand solenoid-actuated valves 20 (FIG. 6).

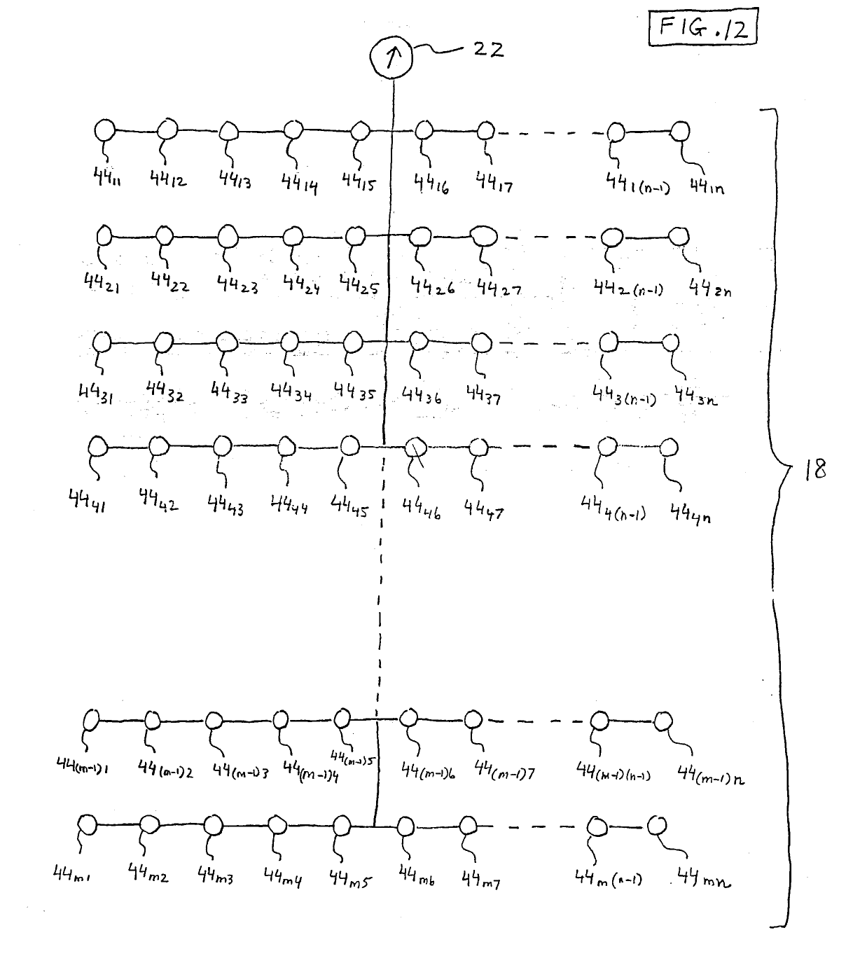

In one preferred form of the present invention, schematically illustrated in FIG. 11, the multi-channel dispensing system 10 (FIG. 4) includes a one-dimensional array of M manifolds 18 with each manifold 18 comprising N channels 44, where M≧1 and N≧1, to create a two-dimensional (M×N) array of channels 44. The manifolds 18 are labeled 18₁ to 18_{M}, and the channels 44 are labeled 44₁₁ to 44_{MN}. Each manifold 18₁ to 18_{M} is hydraulically coupled to a respective one of M syringe pumps 22 which are labeled 22₁ to 22_{M}. Each syringe pump 22₁ to 22_{M} may be fed from a single reagent reservoir 16 (FIG. 4), or alternatively, one or more reagent reservoirs 16. Each channel 44₁₁ to 44_{MN} is in fluid communication with a respective one of (M×N) dispensers 12 (FIG. 4). Preferably, solenoid dispensers 12 (FIG. 6) are utilized in the multi-channel dispensing system, and hence the system will include (M×N) drop-on-demand solenoid-actuated valves 20 (FIG. 6).

As schematically illustrated in FIG. 12, in one preferred embodiment of the present invention the manifold 18 which is hydraulically coupled to a single positive displacement syringe pump 22 comprises a two-dimensional (m×n) array of channels 44, where m≧1, n≧1, and the channels 44 are labeled as channels 44₁₁ to 44ₘₙ. In turn, each channel 44₁₁ to 44ₘₙ is in fluid communication with a respective one of (m×n) dispensers 12 (FIG. 4). Preferably, solenoid dispensers 12 (FIG. 6) are utilized in the multi-channel dispensing system, and hence the system will include (m×n) drop-on-demand solenoid-actuated valves 20 (FIG. 6).

The multi-channel dispensing system of the present invention may also utilize a three-dimensional array of dispensing channels using one or more direct current fluid sources. For example, one or more direct current fluid sources may be coupled to a plurality of channels which comprises several planes of two-dimensional arrays to form a (P×Q×R), where P≧1, Q≧1 and R≧1. Those of ordinary skill in the art will readily recognize that many combinations of the multi-channel dispensing systems schematically illustrated, for example, in FIGS. 10, 11 and 12, can be utilized to form a multi-channel dispensing system in accordance with the present invention.

Operation

As indicated above, the multi-channel dispensing system 10 (FIG. 4) of the present invention can be operated in series (sequential/individual activation or firing of valves), parallel (simultaneous activation or firing of valves) or a combination thereof. In series operation, fluid is dispensed or aspirated from each of the dispenser nozzles 38 (FIG. 6) in succession at predetermined non-overlapping intervals by activating the respective valves 20 (FIG. 6) at predetermined non-overlapping intervals. This can be preferable in situations such as compound reformatting, wherein compounds/reagents are transferred from one source, typically a 96 microwell plate, into another higher density slide or plate such as a 384 or 1536 microwell plate. During series dispensing, the positive displacement pump 22 (FIG. 4) may be operated sequentially at predetermined intervals or it may be operated substantially continuously, as dictated by the particular nature of the application.

Series operation is similar to single-channel positive displacement operation in that the effect of the flow resistances present in the fluid path is generally inconsequential in determining the accuracy, reliability and repeatability of the system 10 (FIG. 4). This is not the case for parallel operation, wherein the flow resistances can greatly affect performance.

Accordingly, one key operational advantage of the multi-channel dispensing system 10 (FIG. 4) of the present invention is that the drop-on-demand valves 20 (FIG. 6) can control and dominate the flow resistance/inductance (impedance) of the system 10. This diminishes, during parallel dispensing, the relative importance of the flow resistances/inductances (impedances) through the feedline 23 (FIG. 4), manifold supply rail 28 (FIG. 4), the manifold channels 44 (FIG. 4), the tips 36 (FIG. 6) and the nozzles 38 (FIG. 6). The adjustable duty cycles of the valves 20 (FIG. 6) provide up to an “infinite” flow resistance/inductance (impedance) when the valves 20 (FIG. 6) are closed, and thus the time-averaged resistance/inductance (impedance) offered by the valves 20 (FIG. 6) can be substantially greater than any other flow resistances in the fluid path. Advantageously, in one embodiment, this results in a generally more even distribution of fluid dispensed through each manifold channel 44 since the fluid provided by the syringe pump 22 (FIG. 4) “views” generally equally large resistances through each of the channels 44 (FIG. 4) and each of the respective dispensers 12 (FIG. 4).

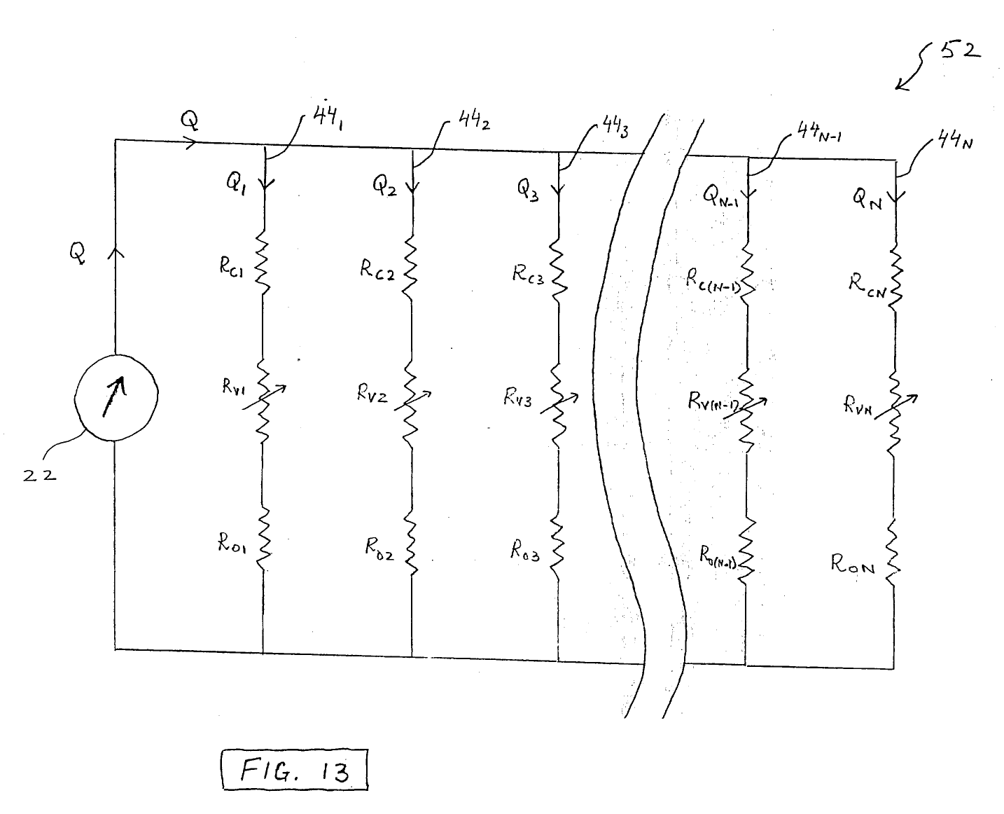

The parallel dispensing operation of the multi-channel dispensing system 10 (FIG. 4) is best exemplified by reference to the fluid circuit schematic 52 (FIG. 13) of the system 10. For illustrative purposes and for the sake of simplicity, only the flow resistances R, and not the inductances and capacitances, are shown in FIG. 13. Since the inductances represent transient resistances they can be combined with the resistances (R) to generate overall “flow impedances.” Thus, though the fluid circuit schematic (FIG. 13) shows flow resistances (R), these resistances can be conceptualized as “flow impedances.” Also, under steady state conditions the elastic capacitance of the positive displacement multi-channel dispensing system 10 (FIG. 4) is substantially inconsequential in determining the fluid volume output from the system 10. Accordingly, for the purpose of this discussion, the elastic capacitances are omitted from the illustrative manifold system fluid circuit schematic 52 (FIG. 13).

Referring to FIG. 13, the fluid circuit schematic 52 comprises a direct current fluid source 22, such as a positive-displacement pump, in parallel with a plurality of N channels 44, where N≧1 and the channels 44 are labeled as channels 44₁ to 44_{N}. In turn, each channel 44₁ to 44_{N} is associated with respective flow resistances R_{c}, Rᵥ and Rₒ in series, where: R_{c1} to R_{cN} represent capillary flow resistances affiliated with the respective channels 44, tips 36 (FIG. 6) and nozzles 38 (FIG. 6); Rₒ₁ to R_{oN} represent orifice flow resistances affiliated with the respective channels 44, tips 36 (FIG. 6) and nozzles 38 (FIG. 6); and Rᵥ₁ to R_{vN} represent flow resistances (capillary and orifice) affiliated with the respective drop-on-demand valves 20 (FIG. 6). The valve resistance Rᵥ represents a suitable time-averaged value since the instantaneous valve flow resistance varies during operation. For example, Rᵥ will be finite when the drop-on-demand valve 20 (FIG. 6) is open and essentially infinite when the valve 20 is closed. During parallel dispensing the drop-on-demand valves 20 (FIG. 6) of the multi-channel dispensing system 10 (FIG. 4) are simultaneously opened and closed at a predetermined frequency and/or duty cycle, thereby resulting in a finite time-averaged Rᵥ.

During parallel dispensing, the time-averaged values of the valve flow resistances (impedances) Rᵥ₁ to R_{vN} will preferably be considerably greater than that of the resistances (impedances) R_{c1} to R_{cN} and Rₒ₁ to R_{oN}. As a result, the resistances (impedances) R_{c1} to R_{cN} and R_{c1} to R_{oN} will play a substantially reduced and preferably inconsequential role in determining how the flow rate Q from the positive displacement means 22 is divided among the channels 44₁ to 44_{N} as respective flow rates Q₁ to Q_{N}. The time-averaged valve flow resistances (impedances) Rᵥ₁ to R_{vN} will largely determine this flow distribution through the respective channels 44₁ to 44_{N}, and hence the output volumes and/or the flow rate of the droplets ejected from each respective drop-forming nozzle 38 (FIG. 6). Typically, it is desired that the flow rate through each channel 44₁ to 44_{N} be about the same so that the output volumes and/or the flow rate of the droplets ejected from each respective drop-forming nozzle 38 (FIG. 6) is about the same. Thus, generally, as long as the time-averaged valve flow resistances (impedances) Rᵥ₁ to R_{vN} are approximately equivalent, the output volumes and/or the flow rate of the droplets ejected from each respective nozzle 38 (FIG. 6) will be about the same.

In many cases, the drop-on-demand valves 20 (FIG. 6) used in the multi-channel dispensing system 10 (FIG. 4) will be fabricated with sufficient precision to ensure that their flow resistances (impedances), Rᵥ₁ to R_{vN} (FIG. 13), are approximately the same when the valves 20 (FIG. 6) are open. But when the valves 20 (FIG. 6) are closed the valve flow resistances (impedances), Rᵥ₁ to R_{vN} (FIG. 13) will be infinite, and hence the time-averaged valve flow resistances (impedances), Rᵥ₁ to R_{vN} (FIG. 13) will largely be determined by the valve open/close frequency and/or duty cycle. In this situation, a generally equal droplet volume and/or flow rate can be attained through each manifold channel 44 (FIG. 4) of the multi-channel dispensing system 10 (FIG. 4) by providing a generally equal and synchronized open time (duty cycle) for each of the drop-on-demand valves 20 (FIG. 6). Of course, differing droplet volumes and/or flow rates may be achieved through the manifold channels 44 (FIG. 4), as required or desired, by adjusting the valve frequency and/or duty cycle of the respective drop-on-demand valves 20 (FIG. 6).

In some cases, dimensional variations between the valves 20 (FIG. 6) and/or the drop-forming nozzles 38 (FIG. 6) or other constrictions in the fluid path may be large enough to affect system output. This situation might arise, for example, when the valve open times are generally large so that the effect of the “infinite” valve resistance (impedance) on the time-averaged valve resistances (impedances) is reduced. Advantageously, the multi-channel dispensing system 10 (FIG. 4) of the present invention can overcome this problem, in one embodiment, by adjusting the duty cycle (duration of valve open time) of one or more of the drop-on-demand valves 20 (FIG. 6), as needed, giving due consideration to the goals of providing reliable, accurate and/or balanced dispensing. In essence, this adjustment of the valve duty cycle(s) is equivalent to adjusting the time-averaged valve flow resistance(s) (impedance(s)). This adaptability of the multi-channel dispensing system 10 (FIG. 4) of the present invention represents a new dimension of control over multi-channel dispensing operations and allows the system to achieve greater stability and precision balanced dispensing and aspirating.

In one embodiment, the multi-channel dispensing system 10 (FIG. 4) incorporates nozzles 38 (FIG. 6) that are removable and replaceable. Typically, in terms of instantaneous flow resistance values, when the valves 20 (FIG. 6) are open, the nozzle flow resistances (impedances) will generally be dominant and will dictate the system pressure. Thus, in the scenario that one or more nozzles 38 (FIG. 6) are severely complicating the operation of the system 10 (FIG. 1), they may be readily replaced. Also, the valves 20 (FIG. 6) may be constructed such that they can provide controlled variable flow resistances (impedances) when they are opened. This can further add to the degree of providing controlled and balanced parallel dispensing.

The dispensed reagent volumes can be measured optically, gravometrically or by using other means. Such measurement techniques and apparatus are well known in the art, and hence will not be discussed in detail herein.

Experimental evidence, for both parallel and sequential operation, has confirmed that differences between the lengths of the manifold channels 44 (FIG. 4) has substantially no effect on the droplet volume and/or flow rate of reagent, as dispensed from the multi-channel dispensing system 10 (FIG. 4) of the present invention. The flexibility in choice of length for the manifold channels 44 (FIG. 4) allows a desirable flexibility in the physical layout and configuration of the manifold 18 (FIG. 4). Also, if needed, it permits one or more of the dispensers 12 (FIG. 4) to be remotely spaced from the others without affecting the performance and effectiveness of the multi-channel dispensing system 10 (FIG. 4).

Further experimental tests have also confirmed the reliability, accuracy and repeatability of the dispense mode of the multi-channel dispensing system 10 (FIG. 4). For instance, repeated experiments conducted using a (1×8) array of channels 44 over a range of operating parameters show that the accuracy of the dispensed volumes from each channel 44 is within about 5% of the target volume. Also, the coefficient of variation between dispensed volumes from different channels is less than about 5%. The multi-channel dispensing system of the present invention can provide droplets having a size in the range from about 10 nanoliters (nL) or less to about 20 microliters (μL) or more.

The absolute accuracy and repeatability of the multi-channel dispensing system 10 (FIG. 4) of the present invention is comparable to the performance of a conventional array of single-channel dispense systems, such as the system disclosed in U.S. Pat. No. 5,743,960. But the multi-channel dispensing system 10 (FIG. 4) of the present invention can be more cost-effective compared to a conventional array of single-channel dispense systems since the former can utilize a single positive displacement pump 22 (FIG. 4) whereas the latter dictates the use of multiple pumps. Also, the multi-channel system 10 (FIG. 4) provides better relative accuracy in terms of balanced channel output. Moreover, and advantageously, the step-resolution requirements on the present invention's stepper motor 26 (FIG. 4) can be comparatively less stringent since the pump output, in one embodiment, is divided among a plurality of dispensing channels.

The present invention by recognizing the fluid mechanical similarities and distinctions between single-channel and multi-channel dispensing provides an innovative dispensing system which permits accurate and reliable multi-channel dispensing. Positive displacement single-channel dispensing systems (with or without drop-on-demand valves) provide a single channel/dispenser in series with the positive displacement source, and hence the flow resistance (impedance) is substantially inconsequential in determining the total fluid output under steady state conditions. This is similar to the sequential (series) activation of the multi-channel system 10 (FIG. 4) of the present invention.

In contrast, during parallel operation the channels in a multi-channel dispensing system are in parallel to the positive displacement means. Therefore, even though under steady state conditions the total input from the positive displacement source equals the total output, the manner in which the flow is divided between the channels is largely determined by the relative channel/dispenser flow resistances (impedances). The present invention preferably provides means, as discussed above, that substantially ensure equalization (or control) of the flow resistances through each channel/dispenser, and hence achieves a generally equal (or desired) fluid output from each manifold channel.

Modes of Operation

The multi-channel dispensing system 10 (FIG. 4) of the present invention can be operated in several modes. These modes include spot or “dot” dispensing, line or continuous dispensing, and aspirating. Dot dispensing is typically the preferred mode for high throughput screening and genomic analysis and research. In the dot dispensing mode, individual droplets can be dispensed at preprogrammed positions. This can be accomplished, for example, by synchronizing the drop-on-demand valves 20 (FIG. 6) and positive displacement pump 22 (FIG. 4) with X, X-Y or X-Y-Z platforms. Under predetermined, and preferably steady state, pressure conditions the metering positive displacement syringe pump 22 is incremented by a predetermined amount to create a hydraulic pressure wave. The drop-on-demand valves 20 (FIG. 6) are coordinated to open and close at predetermined times relative to the pump increment. While the valves 20 (FIG. 6) are open the pressure wave pushes a volume of fluid through the channels 44 (FIG. 4) and down the respective nozzles 38 (FIG. 6) forming droplets at the respective exit orifices at about the time of peak pressure amplitude. The droplets will have a size determined by the incremental volume provided by the positive displacement pump 22 (FIG. 4). During parallel dispensing, in one embodiment, the valve open times/valve pulse widths are chosen to be about the same so that the incremental volume provided by the positive displacement pump 22 (FIG. 4) is approximately equally divided between the manifold channels 44 (FIG. 4). The valve pulse widths may also be selected so that varying amounts of fluid may be dispensed through the manifold channels 44 and/or the drop-on-demand valves 20 (FIG. 6) may be operated sequentially in series or in a combination of series and parallel operation.

The timing, frequency and duty cycle of the drop-on-demand valves 20 (FIG. 6) relative to the syringe pump 22 (FIG. 4) and movable carriage/platform can be coordinated or synchronized by any one of a number controllers well known in the art. Typical controllers are microprocessor based and provide any one of a number of output control pulses or electrical signals of predetermined phase, pulse width and/or frequency. These signals may be used, for example, to control and coordinate the syringe pump 22 (FIG. 4), movable carriage/platform and solenoid valve dispensers 12 (FIG. 4) in accordance with the present invention. A controller 46 is schematically illustrated in FIG. 4.

The continuous or line dispensing mode can be used, for example, in bio-diagnostic applications to create a reagent pattern on a substrate. The multi-channel dispensing system 10 (FIG. 4) may be integrated to an X, X-Y, or X-Y-Z platform wherein the programmed motion control can be coordinated with the metering syringe pump 22 (FIG. 4) to deliver a desired volume per unit length, with the ability to also independently control the frequency and droplet size of the reagent being dispensed. In the continuous dispensing mode, the metering syringe pump 22 (FIG. 4) is set to a prescribed flow rate to deliver a metered volume of reagent in volume-per-unit time. The positive displacement means 22 (FIG. 4) will then pump reagent to the drop-on-demand valves 20 (FIG. 6) at the predetermined rate. By opening and closing the valves 20 (FIG. 6) during this flow, droplets will be formed according to the open time and operating frequency of the respective valves 20 (FIG. 6). During parallel dispensing, in one embodiment, the valve duty cycles are selected to be about the same so that the flow rate is substantially equally divided through the manifold channels 44 (FIG. 4). The valve duty cycles may also be chosen so that varying amounts of fluid may be dispensed through the manifold channels 44 and/or the drop-on-demand valves 20 (FIG. 6) may be operated sequentially in series or in a combination of series and parallel operation. The size of the droplets ejected from the nozzles 38 (FIG. 6) will determine the effective resolution of the resulting patterns formed on the substrate. If desired, a continuous drive reagent pump may also be used to assure a steady flow of reagent to the drop-on-demand dispensers 12 (FIG. 4).

As indicated above, the multi-channel dispensing system 10 (FIG. 4) can also be used to aspirate (“suck”) generally precise and/or predetermined quantities of reagent or other liquids from one or more sources/reservoirs. This mode may be used, for example, in a “suck and spit” operation whereby one or more reagents are aspirated from one or more fluid sources and then dispensed into or onto one or more targets for testing or further processing.

In the aspirate mode the multi-channel dispensing system 10 (FIG. 4) is filled with a wash or system fluid such as distilled water. As discussed in greater detail later herein, the hydraulic pressure within the multi-channel dispensing system 10 (FIG. 4) is adjusted, preferably, to a slightly negative, reduced or close to zero value which is suited for aspiration. The nozzles 38 (FIG. 6) are placed in one or more fluid sources and the syringe pump is decremented, with the valves 20 (FIG. 6) open, to draw precise and/or predetermined quantities of source fluid(s) into the respective tips 36 (FIG. 6) and nozzles 38 (FIG. 6) of the respective dispensers 12 (FIGS. 4 and 6). Preferably, the valves 20 (FIG. 6) are open continuously during aspiration, that is, a 100% duty cycle is utilized. This 100% duty cycle in combination with a very slow syringe speed further reduces the effect of variations in the resistances of the nozzles 38 and/or tips 36 during the aspirate cycle. As discussed in greater detail later herein, the hydraulic pressure within the multi-channel dispensing system 10 (FIG. 4) is again adjusted, preferably, to a predetermined and/or steady state value which is preferred for dispensing. The syringe pump 22 (FIG. 4) is then incremented to dispense precise and/or predetermined portions of the aspirated fluid(s) into or onto one or more targets utilizing one or more of the dispensing methodologies, as discussed above. Typically, once dispensing is complete, a purge/wash function is performed by dispensing any remaining aspirated fluid and some of the wash fluid into a waste position to prepare for the next aspirate-dispense cycle.

A vacuum dry may be used, after aspiration and prior to dispensing, by inserting the nozzles 38 and/or tips 36 (FIG. 6) in vacuum apertures to remove any excess fluid that may have adhered to the outer surfaces of the nozzles 38 and/or tips 36 (FIG. 3) during aspiration. The vacuum dry can also be performed when the system 10 is used in the dispense mode to maintain the quality of dispensing by preventing the buildup of liquid on the outer surface of the nozzles 38 and/or tips 36. The source of this moisture buildup can be from the dispense operation or from fluid condensation from the environment. Optionally, the nozzles 38 and/or tips 36 (FIG. 6) may be coated with a hydrophobic coating, such as teflon, paraffin, fat or a silanized coating among others.

In one form of the present invention, the multi-channel dispensing system 10 (FIG. 4) is operated in series by drawing source fluid by sequentially/individually utilizing a single channel 44 at a time. In another form of the present invention, the aspiration process involves parallel operation by utilizing all of the manifold channels 44 at the same time. The system 10 may also be operated in a combined parallel-series mode to aspirate fluid(s).

When the multi-channel dispensing system 10 (FIG. 4) is operated in parallel to draw fluid(s) simultaneously through all the nozzles 38 (FIG. 6), it is generally preferred that a generally equal volume of fluid(s) is drawn through each of the nozzles 38 (FIG. 6). Thus, the fluid volume drawn through each nozzle 38 (FIG. 6) will approximately equal the volume displacement provided by the syringe pump 22 (FIG. 4) divided by the number of manifold channels 44 (FIG. 4). This is true as long as the flow resistances (impedances) offered to the aspirated fluid(s) by each of the nozzles 38 (FIG. 6) are approximately equal. In this aspect, parallel aspirate operation differs from parallel dispense operation since the drop-on-demand valves 20 (FIG. 6) are preferably continuously open during aspiration, whereas the valves 20 (FIG. 6) are opened and closed at a certain frequency and/or duty cycle during dispensing. Hence, in parallel aspirate mode the nozzle dimensions largely dictate the flow resistances (impedances) as encountered by the aspirated fluid(s) and in the dispense mode the time-averaged flow resistances of the valves 20 (FIG. 6) control and/or dominate the resistance (impedance) of the multi-channel dispensing system 10 (FIG. 4). In one form of the present invention it is desirable to provide sufficiently precision-crafted nozzles 38 (FIG. 6) so that the flow resistances encountered by the aspirated fluid(s) through each nozzle 38 (FIG. 6) is approximately the same. In another form of the invention, an optimally slow syringe speed is used in combination with a 100% aspirate duty cycle to mitigate the effect of any variations in flow resistances between the nozzles 38 and/or tips 36. But such measures may not always be essential since for many practical applications a 20 to 100% variation in aspirate volume may not be critical as long as the total aspirated volume through each nozzle 38 (FIG. 6) is small. In one form of the present invention it is desirable to provide nozzles 38 (FIG. 6) that are replaceable. This further adds to the versatility of the invention and provides a desired control in the selection of the nozzles 38.

Preferably, aspiration of fluid(s) is performed in series by opening a single drop-on-demand valve 20 (FIG. 6) and maintaining all the others in a closed position while the syringe pump 22 (FIG. 4) is decremented by a predetermined amount. In this scenario, the amount of fluid aspirated through the active nozzle 38 (FIG. 6) is substantially independent of its flow resistance (impedance) as well of the resistances (impedances) downstream of the active nozzle 38 (FIG. 6). Thus, by performing the aspirate mode in series, any undesired effects of variations in nozzle dimensions on aspiration volume can be substantially eliminated.

Pressure Compensation

It is desirable to operate the multi-channel dispensing system 10 (FIG. 4) at predetermined hydraulic pressures. For dispensing it is preferred that the system pressure be set at generally steady state conditions. During aspiration it is preferred that the system pressure be slightly negative. It is especially critical to provide efficient and active pressure control when there are frequent transitions between dispense and aspirate modes. In general, pressure control is desired whenever transient pressure variations occur in the hydraulic system. These pressure transients may occur due to hydraulic “capacitance effect”, leakage or the precipitation of small gaseous bubbles, or during initial start-up or intermittent dispensing operations. Advantageously, the pressure pre-conditioning or compensation for the multi-channel dispensing system 10 (FIG. 4) involves adjustment of a single system pressure variable. Comparatively, the system pressure for each single-channel dispenser of a conventional dispensing array would have to be independently adjusted to achieve the same beneficial effects. This would add to the cost and complexity and can simultaneously reduce process speed.

As indicated, the pressure prior to a dispense function is preferably adjusted to a predetermined and/or steady state value. For example, when the multi-channel dispensing system 10 (FIG. 4) is being used in an aspirate-dispense cycle the aspiration process will result in a reduced or negative system pressure which is lower than the desired dispense pressure. Similarly, typically at start-up the system pressure will be close to zero and again this is usually lower than the desired dispense pressure. Prior to dispensing, the initial positive pressure overcomes the system's elastic compliance and thereby achieves a steady state pressure condition. Advantageously, this assures that the fluid displaced by the syringe pump 22 (FIG. 4) will be completely transferred as output through the system nozzle(s) 38 (FIG. 6).

For effective and accurate dispensing of aspirated fluid(s) the system pressure is preferably raised to a positive dispense steady state and/or predetermined value. A simple, fast technique to raise the system pressure to the preferred dispense pressure is by operating the syringe pump 22 (FIG. 4) in the forward direction while keeping the drop-on-demand valves 20 (FIG. 6) in the closed position. Once this preferred “pressurizing” pressure compensation has raised the system pressure to the nominal steady state dispense pressure, the predetermined quantity or quantities of fluid(s) can be accurately dispensed. The pressurization can also be followed by pre-dispensing a small quantity of fluid in a non-target position to fine tune the system pressure to the desired steady state and/or predetermined value.

Also, just preceding an aspirate function a slightly negative or close to zero operating pressure is preferred. Typically, the aspirate function is performed after a purge/wash function or after a dispense function, and hence the hydraulic pressure within the multi-channel dispensing system 10 (FIG. 4) will be substantially higher than the preferred aspirating pressure. This pressure is released by “venting” the system. This may be done in a variety of ways, such as performing-a series of rapid waste dispenses. For example, the nozzle 38 (FIG. 6) may be positioned over a waste receptacle and the drop-on-demand valves 20 (FIG. 6) opened and closed rapidly without operating the syringe pump 22. The opening of the valves 20 (FIG. 6) causes some system fluid and/or any residual aspirated source fluid from the prior aspirate function to be dispensed into the waste position due to the residual pressure within the multi-channel dispensing system 10 (FIG. 4). After several valve openings the residual pressure dissipates and the system pressure stabilizes to a value near zero. Desirably, this “venting” pressure compensation can concurrently serve as a wash function. Optionally, some of the valves 20 (FIG. 6) may be excluded from this pressure venting procedure. Alternatively, the valves 20 (FIG. 6) may remain closed while the syringe pump 22 (FIG. 4) is operated in the reverse direction, as required to release system pressure. The residual pressure may also be released by providing a separate relief valve (not shown) for the syringe pump 22 (FIG. 4) or the shut-off valve 25 (FIG. 4) can be opened to release system fluid 14 (FIG. 4) back into the reservoir 16 (FIG. 4). Once the residual system pressure has been released, the multi-channel dispensing system 10 (FIG. 4) can be used to aspirate fluid(s) as discussed above.

A major part of the hydraulic compressibility or compliance within the system 10 (FIG. 4) is due to precipitated air. The nominal solubility of air in liquids is in the range of about 2%. Even a small amount of this air converted to bubbles within the hydraulic system will dominate the compliance of the system 10. Thus, the dissolved air represents an important variable in determining the compliance or elastic capacitance, C, and hence determining the actuations of the drop-on-demand valve(s) 20 (FIG. 6) and syringe pump 22 (FIGS. 4 and 5) to bring the system to the desired predetermined and/or steady state pressure conditions (as discussed in greater detail herein below). The reagents used with the method of the present invention can be degassed, by using known surfactants. This reduces the influence of precipitated air in the system, and hence simplifies valve and pump actuations, and improved repeatability of the actuations to achieve the desired pressure conditions.

The manifold dispensing apparatus 10 (FIG. 4) can also be configured to minimize the formation and accumulation of gaseous bubbles within the fluid residing in the system 10 and particularly in the manifold 18, feedline 23 and dispensers 12. For example, to minimize bubble formation, the components of the multi-channel dispensing system 10 can be configured so that the fluid movements within the system avoid sharp local pressure drops, and hence gaseous bubble precipitation. Additionally, the components may be configured such that none or few “dead spots” are encountered by the fluid, thereby discouraging bubble accumulation within the system. Optionally, bubble removal means, such as a suitably configured bubble trap may be used.

Estimation of Steady State Pressure (Series Operation)

The importance of performing dispense (and aspirate) functions at the optimal pressures has been illuminated above. The amount of pre-pressurization needed to achieve steady state operation may be determined empirically for a given set-up. An experimental parametric analysis may be performed for a given set-up and several correlations can be obtained. This open-loop control technique will assist in determining the actuations of the syringe pump 22 (FIG. 4) to achieve the optimal operating pressure.

Another preferred approach of estimating the steady state pressure dispense pressure and the system elastic compliance utilizes a semi-empirical methodology. In this case, one or more pressure sensors 55 (FIGS. 4 and 6) may be included with the manifold dispensing system 10 (FIG. 4) to monitor the system pressure. The pressure measurements as provided by one or more pressure sensors 55 (FIGS. 4 and 6) can also be used to provide diagnostic information about various fluid and flow parameters of the hydraulic system. The pressure sensors 55 can be placed at one or more of the drop-on-demand valves 20 (FIG. 6) and/or at appropriate positions intermediate the syringe pump 22 (FIG. 4) and the dispensers 12 (FIG. 4), such as on the feedline 23, as illustrated in FIG. 4. Of course, the pressure sensors 55 may also be placed at other suitable locations, such as at the manifold 18 (FIG. 4), the tips 36 (FIG. 6) or nozzles 38 (FIG. 6), as required or desired, giving due consideration to the goals of providing pressure compensation. Suitable pressure sensors 55 are well known by those of ordinary skill in the art and, accordingly, are not described in greater detail herein. The semi-empirical approach utilizes fluid flow theory and measurements from one or more pressure sensors 55 (FIGS. 4 and 6) positioned at suitable locations.

This semi-empirical estimation of steady state pressure is generally discussed in the context of sequential (series) operation. In this situation the behavior of the multi-channel system 10 (FIG. 4) is similar to a single-channel positive displacement system (as the one disclosed in U.S. Pat. No. 5,743,960) since no more than one channel is active at a given time.

As indicated above, the preferred pre-dispense pressure compensation involves displacing the syringe pump plunger 64 (FIG. 5) while maintaining the valves 20 (FIG. 6) in a closed position. The amount of plunger displacement can be estimated by calculating the elastic compliance and the steady state pressure. The steady state pressure can be estimated, as discussed below, from flow resistance and/or prior steady state or transient pressure measurements. The elastic capacitance, C, can be estimated from:

$$C = \frac{Δ V}{Δ P} \qquad ( 25 )$$

where, ΔV is the change in volume as determined by the displacement of the syringe pump plunger 64 (FIG. 5) and ΔP is the change in pressure as measured by the pressure 5 sensor(s) 55 (FIGS. 4 and 6), with the valves 20 (FIG. 6) closed. Thus, the volume displacement, ΔVₛₛ, of the syringe pump plunger 64 (FIG. 5) required to achieve steady state pressure conditions, Pₛₛ, can be estimated by using:

ΔVₛₛ=C(P−Pₛₛ) (26)

where, P in equation (26) is the instantaneous pressure as measured by the pressure sensor(s) 55 (FIGS. 4 and 6). By constantly or periodically monitoring the pressure, P, as the syringe pump plunger 64 (FIG. 5) is moved a continuous or periodic and updated measurement of the elastic compliance, C, can be iteratively used in equation (26) until the pressure converges to the steady state value.

If pressure compensation prior to an aspirate function is provided by displacing the plunger 64 (FIG. 5) to reduce the system pressure with the valves 20 (FIG. 6) in the closed position, equation (26) can be similarly used to estimate the plunger displacement. In this case, and as discussed before, the desired aspirating pressure will typically be slightly negative or close to zero.

As indicated above, the steady state pressure can be estimated from flow resistance and/or prior steady state or transient pressure measurements. An estimate of the steady state pressure can be made by calculating the active nozzle's pressure or pressure drop based on a theoretical computation of the nozzle capillary flow resistance (R_{c}) and the nozzle orifice flow resistance (Rₒ) by using the following:

$${R}_{c} = \frac{8 μ L \_nom}{{π ( \frac{D\_nom}{2} )}^{4}} \qquad ( 27 )$$

$${R}_{o} = \frac{\sqrt{\frac{ρ}{2}}}{{C}_{d} {π ( \frac{D\_nom}{2} )}^{2}} \qquad ( 28 )$$

where, ρ is the fluid density, μ is the fluid viscosity, L_nom is the nominal nozzle length, D_nom is the nominal nozzle diameter, and C_{d} is the discharge coefficient. The nozzle pressure drop or total input pressure, Psᵢₙ, can be calculated from the following:

Ps_{cap}=QR_{c} (29)

Ps_{orf}=(QRₒ)² (30)

Psᵢₙ=Ps_{cap}+Ps_{orf} (31)

where, Ps_{cap} is the pressure drop due to the nozzle capillary resistance, Ps_{orf} is the pressure drop due to the nozzle orifice flow resistance and Q is the flow rate as provided by the syringe pump 22 (FIG. 4) during dispensing.

Psᵢₙ, the nozzle pressure drop, is an estimate of the desired dispensing steady state pressure, during series operation, within the multi-channel dispensing system 10 (FIG. 4). This is because preferably the bulk of the instantaneous pressure drop through the system 10 (FIG. 4) is across the active nozzle 38 (FIG. 6).

An estimate of the steady state pressure can also be obtained by estimating the nozzle capillary and orifice flow resistances by utilizing pressure measurements from the sensor(s) 55 (FIGS. 4 and 6) during sequential dispensing (one active nozzle). The capillary flow resistance and the orifice flow resistance can be estimated by making two measurements of the system pressure at two flow rates during steady state dispensing from the following:

$$Rc\_est = \frac{{P}_{l} {Q}_{h}^{2} - {P}_{h} {Q}_{l}^{2}}{{Q}_{h} {Q}_{l} ( {Q}_{h} - {Q}_{l} )} \qquad ( 32 )$$

$$Ro\_est = \sqrt{\frac{{P}_{h} {Q}_{l} - {P}_{l} {Q}_{h}}{{Q}_{h} {Q}_{l} ( {Q}_{h} - {Q}_{l} )}} \qquad ( 33 )$$

where, Q₁ is the low flow rate, Qₕ is the high flow rate, P₁ is the pressure measurement at Q₁, Pₕ is the pressure measurement at Qₕ, Rc_est is the estimate of the capillary flow resistance and Ro_est is the estimate of the orifice flow resistance. The two pressure measurements, P₁ and Pₕ, can be made during steady state on-line dispensing by modulating the flow rate about the operating point by a small amount, for example, about ±5%. Optionally, a calibration mode can be used off-line to make the pressure measurements. Once estimates of the capillary flow resistance, Rc_est, and the orifice flow resistance, Ro_est, have been determined, these can be used in conjunction with equations (29), (30) and (31) to obtain an estimate of the nozzle pressure drop, Psᵢₙ, which can be estimated as a steady state pressure.

Advantageously, the above semi-empirical estimates of the capillary flow resistance, Rc_est, and the orifice flow resistance, Ro_est, permit the density and viscosity of the fluid to be estimated by using:

$$\begin{matrix}μ\_est = \frac{{πRc\_est [ \frac{D\_nom}{2} ]}^{4}}{8 L\_nom} & ( 34 ) \\ ρ\_est = {2 [ {πC}_{d} \frac{{D\_nom}^{2}}{4} Ro\_est ]}^{2} & ( 35 )\end{matrix}$$

where, ρ_est is the estimated fluid density and μ_est is the estimated fluid viscosity.

In the case that an initial pressure transient is encountered prior to steady state dispensing, transient pressure measurements utilizing the pressure sensor(s) 55 (FIGS. 4 and 6) can be used to estimate the nozzle capillary and orifice flow resistances. This approach is generally accurate only when the initial pressure is within 30-50% of the steady state value because a linearized approximation of the differential equations is used. The linearized pressure equations for an initial pressure of Pi at the time that pulsed dispensing operation begins and decays to the steady state value of Pₛₛ can be approximated by:

$$\begin{matrix}P ( t ) = {P}_{ss} + ( {P}_{i} - {P}_{ss} ) {ⅇ}^{- \frac{t}{α} ( {F}_{valve} {T}_{v} )} & ( 36 ) \\ α = C [ {R}_{c} + 2 \frac{{R}_{0}^{2} {Q}_{step}}{{F}_{valve} {T}_{v}} ] & ( 37 ) \\ {P}_{ss} = {R}_{0}^{2} {Q}_{nozzle}^{2} + {R}_{c} {Q}_{nozzle} & ( 38 ) \\ {Q}_{nozzle} = \frac{{Q}_{step}}{{F}_{valve} {T}_{v}} & ( 39 )\end{matrix}$$

where, P(t) is the instantaneous pressure as a function of time t, α is the system time constant, Fᵥₐₗᵥₑ is the open-close frequency of the active drop-on-demand-valve 20 (FIG. 6), Tᵥ is the valve open time/valve pulse width of the active drop-on-demand-valve 20 (FIG. 6), C is the elastic capacitance, Qₛₜₑₚ is the instantaneous flow rate as provided by the syringe pump 22 (FIG. 4) which is operated by the stepper motor 26 (FIG. 4), and Q_{nozzle} is the instantaneous flow rate through the active nozzle 38 (FIG. 6). The elastic capacitance, C, can be estimated from pressure and volume changes with the valves 20 (FIG. 6) closed, as is discussed above. Note that (FᵥₐₗᵥₑTᵥ) is a scaling factor since the active drop-on-demand valve 20 (FIG. 6) is not open all the time in pulsed dispensing operation. If the valve 20 is open continuously, this scaling factor reverts to 1 since the instantaneous nozzle flow rate, Q_{nozzle}, and the stepper flow rate, Qₛₜₑₚ, are the same.

The above equations (36) to (39) can be manipulated to give:

$$\begin{matrix}α = \frac{{t}_{1}}{ln ( \vert {P}_{i} - {P}_{ss} \vert ) - ln ( \vert {P}_{1} - {P}_{ss} \vert )} {F}_{valve} {T}_{v} & ( 40 ) \\ Rc\_est = \frac{{F}_{valve}}{{Q}_{step}} [ 2 {P}_{ss} {T}_{v} - \frac{{Q}_{step} α}{{F}_{valve} C} ] & ( 41 ) \\ Ro\_est = \frac{{F}_{valve}}{{Q}_{step}} \sqrt{[ \frac{{Q}_{step} α}{{CF}_{valve}} - {P}_{ss} {T}_{v} ] {T}_{v}} & ( 42 )\end{matrix}$$

where, Pᵢ is the measured initial pressure prior to dispensing, Pₛₛ is the measured steady state pressure after a substantially long time, and P₁ is the measured pressure during decay at time t₁. These pressures can be measured using the pressure sensor(s) 55 (FIGS. 4 and 6). The pressure P₁ can be measured at several different times and the results averaged to reduce noise. In this manner estimates of the nozzle capillary flow resistance, Rc_est, and nozzle orifice flow resistance, Ro_est, can be obtained. These estimates of the capillary flow resistance, Rc_est, and the orifice flow resistance, Ro_est, can be used in conjunction with equations (29), (30) and (31) to obtain an estimate of the nozzle pressure drop, Psᵢₙ, which can be estimated as a steady state pressure.

While the components and techniques of the present invention have been described with a certain degree of particularity, it is manifest that many changes may be made in the specific designs, constructions and methodology hereinabove described without departing from the spirit and scope of this disclosure. It should be understood that the invention is not limited to the embodiments set forth herein for purposes of exemplification, but is to be defined only by a fair reading of the appended claims, including the full range of equivalency to which each element thereof is entitled.

What is claimed is:

1. A multi-channel system for aspirating or dispensing precise and/or predetermined microfluidic quantities of a fluid, comprising:
a plurality of valves adapted to be opened and closed at a predetermined frequency and duty cycle;
a direct current fluid source in hydraulic communication with said plurality of valves for metering predetermined quantities of said fluid to said plurality of valves; and
a manifold positioned intermediate said plurality of valves and said direct current fluid source and including a plurality of channels in hydraulic communication with a respective one of said plurality of valves.

2. The multi-channel system of claim 1, wherein said direct current fluid source comprises a positive displacement device.

3. The multi-channel system of claim 2, wherein said positive displacement device comprises a syringe pump.

4. The multi-channel system of claim 3, wherein said positive displacement device further comprises a stepper motor adapted to cause said syringe pump to draw/provide predetermined quantities of said fluid from/to said plurality of drop-on-demand valves.

5. The multi-channel system of claim 1, wherein said plurality of valves comprises drop-on-demand valves.

6. The multi-channel system of claim 1, wherein said plurality of valves comprises solenoid-actuated valves.

7. The multi-channel system of claim 1, further including a plurality of nozzles in communication with a respective one of said plurality of valves.

8. The multi-channel system of claim 1, further including one or more pressure sensors for monitoring the hydraulic pressure within said multi-channel system.

9. The multi-channel system of claim 1, wherein said plurality of channels comprises a (1×N) array of channels.

10. The multi-channel system of claim 9, wherein N=8.

11. The multi-channel system of claim 1, in combination with a plurality of said multi-channel systems to form a two-dimensional multi-channel dispense/aspirate system comprising an (M×N) array of said channels.

12. A system for aspirating generally precise and/or predetermined microfluidic quantities of one or more fluids from one or more fluid sources or dispensing precise and/or predetermined microfluidic quantities of said one or more fluids to one or more targets, comprising:
a plurality of valves adapted to be opened and closed at a predetermined frequency and duty cycle;
a plurality of nozzles coupled to a respective one of said plurality of valves and adapted to be immersed in said one or more fluid sources;
a positive displacement pump in hydraulic communication with said plurality of valves for drawing predetermined quantities of said one or more fluids from said one or more fluid sources and/or for providing predetermined quantities of said one or more fluids to said one or more targets;
a manifold positioned intermediate said plurality of valves and said positive displacement pump and including a plurality of channels in hydraulic communication with a respective one of said plurality of valves; and
a controller for individually controlling the frequency/duty cycle of said plurality of valves to achieve balanced output and/or to achieve individual or sequential dispensing/aspirating of precise and/or predetermined quantities of said one or more fluids.

13. The system of claim 12, further comprising movable X, X-Y or X-Y-Z platforms synchronized with the actuations of said plurality of valves and said positive displacement pump.

14. The system of claim 12, further comprising one or more robot arms to provide relative motion synchronized with the actuations of said plurality of valves and said positive displacement pump.

15. The system of claim 12, wherein said plurality of valves comprises drop-on-demand valves.

16. The system of claim 12, wherein said plurality of valves comprises piezo-electric valves.

17. The system of claim 12, further including one or more pressure sensors for monitoring the hydraulic pressure within said system.

18. The system of claim 12, wherein said plurality of channels comprises a (1×N) array of channels.

19. The system of claim 18, wherein N=8.

20. The system of claim 12, in combination with a plurality of said systems to form a two-dimensional multi-channel system comprising an (M×N) array of said channels.

21. An apparatus for dispensing and aspirating one or more fluids, comprising:
a plurality of dispensers;
a direct current fluid source in hydraulic communication with said plurality of dispensers for metering predetermined quantities of said one or more fluids to or from said plurality of dispensers;
a manifold positioned intermediate said plurality of dispensers and said direct current fluid source and including a plurality of channels in hydraulic communication with a respective one of said plurality of dispensers; and
means for individually controlling each of the dispensers to achieve balanced output and/or to achieve individual or sequential dispensing/aspirating of precise and/or predetermined quantities of said one or more fluids.

22. The apparatus of claim 21, wherein said plurality of dispensers comprises solenoid-actuated dispensers.

23. The apparatus of claim 21, wherein said plurality of dispensers comprises piezoelectric dispensers.

24. The apparatus of claim 21, wherein said plurality of dispensers comprises aerosol dispensers.

25. The apparatus of claim 21, wherein said plurality of dispensers comprises magneto-constriction dispensers.

26. The apparatus of claim 21, wherein said plurality of dispensers comprises fluid impulse dispensers.

27. The apparatus of claim 21, wherein said plurality of dispensers comprises heat actuated dispensers.

28. The apparatus of claim 21, further including one or more pressure sensors for monitoring the hydraulic pressure within said apparatus.

29. The apparatus of claim 21, wherein said plurality of channels comprises a (1×N) array of channels.

30. The apparatus of claim 21, in combination with a plurality of said apparatuses to form a two-dimensional dispensing/aspirating system comprising an (M×N) array of said channels.

31. A system for dispensing and aspirating predetermined quantities of one or more reagents, comprising:
a plurality of dispensers with each one of said plurality of dispensers including a respective one of a plurality of drop-on-demand valves adapted to be opened and closed at a predetermined frequency and duty cycle, each one of said plurality of drop-on-demand valves being in communication with a respective one of a plurality of nozzles for dispensing droplets of said one or more reagents onto one or more targets or for aspirating said one or more reagents from one or more sources;
a positive displacement syringe pump in hydraulic communication with said plurality of drop-on-demand valves and including a stepper motor adapted to decrement or increment a plunger of said positive displacement syringe pump for metering predetermined quantities of said one or more reagents to or from said plurality of dispensers;
a manifold positioned intermediate said plurality of dispensers and said positive displacement syringe pump and being in hydraulic communication with said plurality of dispensers and said positive displacement syringe pump, said manifold including a supply rail and a plurality of channels in hydraulic communication with a respective one of said plurality of drop-on-demand valves to form an (1×N) array of said plurality of channels for dispensing or aspirating said one or more reagents;
one or more pressure sensors placed intermediate said manifold and said positive displacement syringe pump and/or at said manifold and/or at said one or more of said plurality of dispensers;
whereby, said system can provide controlled and/or generally equal quantities and/or flow rates of said one or more reagents to or from one or more of said plurality of dispensers.

32. The system of claim 31, in combination with a plurality of said systems to form a two-dimensional dispensing/aspirating system comprising an (M×N) array of said channels.

33. The system of claim 31, in combination with a vacuum dry system for removing excess fluid from the outer surfaces of said plurality of nozzles.

34. A method for substantially balanced multi-channel dispensing, comprising the steps of:
providing a plurality of dispensers connected to a common supply manifold and including a plurality of valves;
providing a pump in series with said manifold;
actuating said pump to displace a predetermined quantity of fluid;
actuating one or more of said plurality of dispensers to provide a quantity or quantities of said fluid to a target; and
controlling the duty cycle and/or frequency of one or more of said plurality of valves to achieve substantially balanced flow.

35. The method of claim 34, wherein said step of controlling includes the step of providing a substantially large and equal time-averaged flow resistance/impedance through each one of said plurality of valves.

36. A method for sequentially dispensing a fluid, comprising the steps of:
providing a plurality of dispensers connected to a common supply manifold and including a plurality of valves;
providing a direct current fluid source in series with said manifold;
actuating said direct current fluid source to sequentially or continuously displace predetermined quantities of fluid;
actuating said plurality of dispensers sequentially/individually at predetermined intervals to provide a quantity or quantities of said fluid to one or more targets.

37. A hydraulic system for sequentially dispensing precise and/or predetermined quantities of fluid, comprising:
a plurality of dispensers connected to a common supply manifold and including a plurality of valves adapted to be activated at predetermined intervals;
a direct current fluid source in fluid communication with said manifold;
the output fluid flow rate (Qₙ) through each one of said plurality of valves of said hydraulic system being substantially in accordance with a transfer function having the form:
$$\frac{{Q}_{n}}{{Q}_{t}} = \frac{\frac{K}{s ( s + \frac{1}{τ} )}}{1 + \frac{K}{s ( s + \frac{1}{τ} )}} = \frac{1}{1 + \frac{1}{K} s ( s + \frac{1}{τ} )}$$
with a characteristic equation given by:
$$1 + \frac{K}{s ( s + \frac{1}{τ} )} = 0$$
and a gain K given by:
$$K = \frac{1}{{R}_{t} C τ}$$
where, Qₜ is the input fluid flow rate provided by said direct current fluid source to each one of said plurality of valves, Rₜ is the flow resistance, C is the elastic capacitance, τ is the inertial or inductive time constant, and s is the Laplacian variable.
